(19) United States
(12) Patent Application Publication
(10) Pub. No.: US 2014/0213114 A1
(43) Pub. Date: Jul. 31, 2014

(54) CONNECTOR AND MATING CONNECTOR CONNECTABLE TO THE SAME

(71) Applicant: HOSIDEN CORPORATION, Yao-shi (JP)

(72) Inventor: Masaya ISODA, Yao-shi (JP)

(73) Assignee: HOSIDEN CORPORATION, Yao-shi (JP)

(21) Appl. No.: 14/163,050

(22) Filed: Jan. 24, 2014

(30) Foreign Application Priority Data
Jan. 28, 2013 (JP) 2013-012936

(51) Int. Cl. H01R 13/516

(52) U.S. Cl. CPC H01R 13/516
USPC 439/626

(57) ABSTRACT

The invention provides a connector including a body, first, second, third, and fourth terminals, and first and second connection objects. The body includes a first recess including a first bottom and a first side wall, and a second recess including a second bottom and a second side wall. The first terminal includes a first connecting portion provided in or on the first bottom, or with clearance from the first bottom. The second terminal includes a second connecting portion provided in or on the first side wall. The third terminal includes a third connecting portion provided in or on the second bottom, or with clearance from the second bottom. The fourth terminal includes a fourth connecting portion provided in or on the second side wall. The first connection object is connected to the first and second connecting portions. The second connection object is connected to the third and fourth connecting portions.

### CROSS-REFERENCE TO RELATED APPLICATIONS

The present application claims priority under 35 U.S.C. §119 of Japanese Patent Application No. 2013-012936 filed on Jan. 28, 2013, the disclosure of which is expressly incorporated by reference herein in its entity.

### BACKGROUND OF THE INVENTION

1. Technical Field

The present invention relates to connectors and mating connectors connectable to the same.

2. Background Art

U.S. Pat. No. 7,485,008 discloses a conventional connector including a insulating body, a first terminal group, a second terminal group, and a cable.

### SUMMARY OF INVENTION

At least one of the first and second terminal groups includes a pair of signal terminals and a pair of power terminals. The signal terminals are used to transmit and receive signals, and the power terminals are used to supply power. The signal terminals and the power terminals are connected to core wires of the cable.

The above connector is demanded to supply power with a pair of or a plurality of pairs of power terminals. In other words, the connector is demanded to supply power in a single electrical system or a plurality of systems. However, the connector with a plurality of pairs of power terminals should require space for connection between the power terminal and the core wire (connection object) of the cable in accordance with the number of the power terminals and the core wires, resulting in the upsizing of the connector.

In view of the above-mentioned circumstances, the invention is devised to provide a connector with reduced space for connection between the terminals and the connection objects.

A first connector of the invention includes a body, first, second, third, and fourth terminals, and first and second connection objects. The body has an insulation property. The body includes a connection part and first and second recesses. The first recess includes a first bottom and a first side wall. The second recess includes a second bottom and a second side wall. The first, second, third, and fourth terminals are held by the body. The first terminal includes a first contact portion and a first connecting portion. The first contact portion is provided at the connection part of the body. The first connecting portion is provided in the first bottom of the body so as to be exposed from the first bottom, or provided on the first bottom, or provided with clearance from the first bottom. The second terminal includes a second contact portion and a second connecting portion. The second contact portion is provided at the connection part of the body. The second connecting portion is provided in the first side wall of the body so as to be exposed from the first side wall, or provided on the first side wall. The third terminal includes a third contact portion and a third connecting portion. The third contact portion is provided at the connection part of the body. The third connecting portion is provided in the second bottom of the body so as to be exposed from the second bottom, or provided on the second bottom, or provided with clearance from the second bottom. The fourth terminal includes a fourth contact portion and a fourth connecting portion. The fourth contact portion is provided at the connection part of the body. The fourth connecting portion is provided in the second side wall of the body so as to be exposed from the second side wall, or provided on the second side wall. The first connection object is connected to the first and second connecting portions in the first recess. The second connection object is connected to the third and fourth connecting portions in the second recess.

In the first connector of this aspect, the first connecting portion is provided at the first bottom of the first recess, and the second connecting portion is provided at the first side wall of the first recess. The first connection object is connected to the first connecting portion and the second connecting portion together in the first recess. The third connecting portion is provided at the second bottom of the second recess, and the fourth connecting portion is provided at the second side wall of the second recess. The second connection object is connected to the third connecting portion and the fourth connecting portion together in the second recess. These arrangements can reduce the connection space for connecting the first connection object to the first and second connecting portions of the first and second terminals, and the connection space for connecting the second connection object to the third and fourth connecting portions of the third and fourth terminals. If the first, second, third, and fourth terminals are used as terminals for power supply, power can be supplied by way of one of the first and second terminals and one of the third and fourth terminals (i.e. power supply in one electrical system), or by way of the first, second, third, and fourth terminals (i.e. power supply in a plurality of electrical systems).

The second connecting portion may include a first portion and a second portion. The first portion of the second connecting portion may be provided in the first side wall of the body so as to be exposed from the first side wall, or provided on the first side wall. The second portion may be contiguous with the first portion and located under and in contact with the first connecting portion. The fourth connecting portion may include a first portion and a second portion. The first portion of the fourth connecting portion may be provided in the second side wall of the body so as to be exposed from the second side wall, or provided on the second side wall. The second portion of the fourth connecting portion may be contiguous with the first portion of the fourth connecting portion and located under and in contact with the third connecting portion.

In the first connector of this aspect, the second connecting portion includes the first and second portions, and the first connecting portion is in physical and electrical contact with the second portion of the second connecting portion. This arrangement can increase the connection area of the first connection object with respect to the first and second connecting portions. Further advantageously, electrical connection is established between the first connection object and both the first and second connecting portions, by connecting the first connection object to at least one of the connecting portions. This arrangement can improve the reliability of connection between the first connection object and the first and second terminals. The fourth connecting portion includes the first and second portions, and the third connecting portion is in physical and electrical contact with the second portion of the fourth connecting portion. This arrangement can increase the connection area of the second connection object with respect to the third and fourth connecting portions. Further advantageously, electrical connection is established between the second connection object and both the third and fourth connecting portions, by connecting the second connection object to at least one of the connecting portions. This arrangement can improve the reliability of connection between the second connection object and the third and fourth terminals.

The first connecting portion may have smaller outer dimensions than the second portion of the second connecting portion. The third connecting portion may have smaller outer dimensions than the second portion of the fourth connecting portion.

In the first connector of this aspect, the second portion of the second connecting portion is partially exposed outside the first connecting portion. The second portion of the fourth connecting portion is partially exposed outside the third connecting portion. These arrangements can increase the area for connection between the first connection object and the first and second connecting portions, and the area for connection between the second connection object and the third and fourth connecting portions. Therefore, it is possible to further improve the reliability of connection between the first connection object and the first and second terminals, and between the second connection object and third and fourth terminals.

Alternatively, the second portion of the second connecting portion may be disposed on top of, not under, and in contact with the first connecting portion. The second portion of the fourth connecting portion may be disposed on top of, not under, and in contact with the third connecting portion.

In the first connector of this aspect, the second connecting portion includes the first and second portions, and the first connecting portion is in physical and electrical contact with the second portion of the second connecting portion. This arrangement can increase the connection area of the first connection object with respect to the first and second connecting portions. Further advantageously, electrical connection is established between the first connection object and both the first and second connecting portions, by connecting the first connection object to at least one of the connecting portions. This arrangement can improve the reliability of connection between the first connection object and the first and second terminals. The fourth connecting portion includes the first and second portions, and the third connecting portion is in physical and electrical contact with the second portion of the fourth connecting portion. This arrangement can increase the connection area of the second connection object with respect to the third and fourth connecting portions. Further advantageously, electrical connection is established between the second connection object and both the third and fourth connecting portions, by connecting the second connection object to at least one of the connecting portions. This arrangement can improve the reliability of connection between the second connection object and the third and fourth terminals.

The second portion of the second connecting portion may have smaller outer dimensions than the first connecting portion. The second portion of the fourth connecting portion may have smaller outer dimensions than the third connecting portion.

In the first connector of this aspect, the first connecting portion is partially exposed outside the second portion of the second connecting portion. The third connecting portion is partially exposed outside the second portion of the fourth connecting portion. These arrangements can increase the area for connection between the first connection object and the first and second connecting portions, and the area for connection between the second connection object and the third and fourth connecting portions. Therefore, it is possible to further improve the reliability of connection between the first connection object and the first and second terminals, and between the second connection object and third and fourth terminals.

A second connector of the invention includes a body, first, second, third, and fourth terminals, and first and second connection objects. The body has an insulation property. The body includes a connection part and first and second recesses. The first recess includes a first bottom and a first side wall. The second recess includes a second bottom and a second side wall. The first, second, third, and fourth terminals are held by the body. The second terminal includes a second contact portion and a second connecting portion. The second contact portion is provided at the connection part of the body. The second connecting portion is provided on the first bottom of the body. The first terminal includes a first contact portion and a first connecting portion. The first contact portion is provided at the connection part of the body. The first connecting portion is provided on the second connecting portion. The fourth terminal includes a fourth contact portion and a fourth connecting portion. The fourth contact portion is provided at the connection part of the body. The fourth connecting portion is provided on the second bottom of the body. The third terminal includes a third contact portion and a third connecting portion. The third contact portion is provided at the connection part of the body. The third connecting portion is provided on the fourth connecting portion. The first connection object is connected to the first and second connecting portions in the first recess. The second connection object is connected to the third and fourth connecting portions in the second recess.

In the second connector of this aspect, the first and second connecting portions are stacked on the first bottom of the first recess. The third and fourth connecting portions are stacked on the first bottom of the second recess. The first connection object is connected to the second and first connecting portions together in the first recess. The second connection object is connected to the fourth and third connecting portions together in the second recess. These arrangements can reduce the connection space for connecting the first connection object to the first and second connecting portions of the first and second terminals, and the connection space for connecting the second connection object to the third and fourth connecting portions of the third and fourth terminals can be reduced. If the first, second, third, and fourth terminals are used as terminals for power supply, power can be supplied by way of one of the first and second terminals and one of the third and fourth terminals (i.e. power supply in one electrical system), or by way of the first, second, third, and fourth terminals (i.e. power supply in a plurality of electrical systems).

The first and second connecting portions may be integral with each other. The third and fourth connecting portions may be integral with each other. The first and second connectors of this aspect can be manufactured with a reduced number of components.

The first and second connector may each further include a cable. The cable may include a first core wire serving as the first connection object and a second core wire serving as the second connection object.

The first and second contact portions may be provided at the connection part so as to be at least partially exposed from different places of the connection part. The third and fourth contact portions may be provided at the connection part so as to be at least partially exposed from different places of the connection part.

A first mating connector of the invention is connectable with the first and second connectors according to any of above aspects. The first mating connector includes a body, a signal terminal, and first, second, third, and fourth power terminal. The body has an insulation property. The signal terminal is held by the body of the mating connector. The first power terminal is held by the body of the mating connector so as to be contactable with the third contact portion of the third terminal. The second power terminal is held by the body of the mating connector so as to be contactable with the fourth contact portion of the fourth terminal. The third power terminal is held by the body of the mating connector so as to be contactable with the first contact portion of the first terminal. The fourth power terminal is held by the body of the mating connector so as to be contactable with the second contact portion of the second terminal.

The first mating connector of this aspect is applicable to power supply through a plurality of electrical systems, by bringing the first power terminal into contact with the third contact portion of the third terminal, the second power terminal into contact with the fourth contact portion of the fourth terminal, the third power terminal into contact with the first contact portion of the first terminal, and the fourth power terminal into contact with the second contact portion of the second terminal. The first mating connector can perform signal transmission also with another type of connector, by bringing the signal terminal into contact with a terminal of the another type of connector.

The body may include a base and first and second protruding parts. The first protruding part is provided on the base. The second protruding part may be provided on the first protruding part. The first, second, third, and fourth power terminals may include first, second, third, and fourth contact portions, respectively, partially exposed from the first protruding part. The signal terminal may include a contact portion partially exposed from the second protruding part.

In the first mating connector of this aspect, the contact portion of the signal terminal, and the first, second, third, and fourth contact portions of the first, second, third, and fourth power terminals are exposed from different places (from the second and first protruding parts, respectively) of the body. This arrangement can prevent undesirable contact of the signal terminal with any of the third, fourth, first, and second contact portions of the third, fourth, first, and second terminals when bringing the first, second, third, and fourth power terminals into contact with the first, second, third, and fourth contact portions of the first, second, third, and fourth terminals. The above arrangement can also prevent undesirable contact of the first, second, third, and fourth power terminals with any of the contacts of the another type of connector when bringing the signal terminal with the contacts of the another type of connector.

The exposed parts of the first and second contact portions may be exposed from different places of the first protruding part. The exposed parts of the third and fourth contact portions may be exposed at different places of the first protruding part.

A second mating connector of the invention is connectable with a connector according to any of above aspects. The second mating connector includes a body, a signal terminal, a pair of power terminals. The body has an insulation property. The signal terminal is held by the body of the mating connector. The power terminals are held by the body of the mating connector. One of the power terminals is contactable with one of the first and second contact portions of the first and second terminals. The other power terminal is contactable with one of the third and fourth contact portions of the third and fourth terminals.

In the second mating connector of this aspect, one of the power terminal is in contact with one of the first and second contact portions of the first and second terminals, and the other power terminal is in contact with one of the third and fourth contact portions of the third and fourth terminals, allowing power supply through one electrical system. The second mating connector can perform signal transmission also with another type of connector, by bringing the signal terminal into contact with a terminal of the another type of connector.

The body of the mating connector may include a base, and first and second protruding parts. The first protruding part may be provided on the base. The second protruding part may be provided on the first protruding part. The power terminals may each include a contact portion partially exposed from the first protruding part. The signal terminal may include a contact portion partially exposed from the second protruding part.

In the second mating connector of this aspect, the contact portion of the signal terminal and the contact portions of the power terminals are exposed from the different places (from the second and first protruding parts, respectively) of the body. This arrangement can prevent undesirable contact of the signal terminal with any of the first, second, third, and fourth contact portions of the first, second, third, and fourth terminals when bringing one of the power terminal into contact with one of the first and second contact portions of the first and second terminals and the Other power terminal into contact with one of the third and fourth contact portions of the third and fourth terminals. The above arrangement can also prevent undesirable contact of the power terminals with any of the contacts of the another type of connector when bringing the signal terminal with the contacts of the another type of connector.

### BRIEF DESCRIPTION OF DRAWINGS

FIG. 1 is a perspective view of a connector in accordance with an embodiment of the invention as viewed from the front, top, right side.

FIG. 2A is a cross-sectional view of the connector taken along 2A-2A in FIG. 1, with a case illustrated as transparent.

FIG. 2B is a cross-sectional view of the connector taken along 2B-2B in FIG. 1, with the case illustrated as transparent.

FIG. 2C is a sectional view of the connector taken along 2C-2C in FIG. 1, with the case illustrated as transparent.

FIG. 3A is a perspective view of a body, terminals, lock pieces, a cable, and a shield case of the connector as viewed from the front, top, right side.

FIG. 3B is a perspective view of the body, the terminals, the lock pieces, the cable, and the shield case of the connector as viewed from the front, bottom, left side.

FIG. 4A is a perspective view of the body, the terminals, the lock pieces, and the cable of the connector as viewed from the front, top, right side.

FIG. 4B is a perspective view of the body, the terminals, the lock pieces, and the cable of the connector as viewed from the back, bottom, right side.

FIG. 4C is a perspective view of the body, the terminals, and the lock pieces of the connector as viewed from the back, bottom, right side.

FIG. 5A is a perspective view of the body of the connector as viewed from the front, top, right side.

FIG. 5B is a perspective view of the body of the connector as viewed from the back, bottom, right side.

FIG. 6A is a perspective view of the terminals of the connector as viewed from the, top, right side.

FIG. 6B is a perspective view of the terminals of the connector as viewed from the back, bottom, right side.

FIG. 7A is a perspective view of the lock pieces of the connector as viewed from the front, top, right side.

FIG. 7B is a perspective view of the lock pieces of the connector as viewed from the back, the bottom, and the right side.

FIG. 8A is a perspective view of a mating connector in accordance with an embodiment of the invention as viewed from the front, top, right side.

FIG. 8B is a perspective view of the mating connector as viewed from the back, bottom, right side.

FIG. 9A is a sectional view of the mating connector taken along 9A-9A in FIG. 8A.

FIG. 9B is a sectional view of the mating connector taken along 9B-9B in FIG. 8A.

FIG. 9C is a sectional view of the mating connector taken along 9C-9C in FIG. 8A.

FIG. 10A is a perspective view of a body, signal terminals, and power terminals of the mating connector as viewed from the front, bottom, left side.

FIG. 10B is a perspective view of the body, the signal terminals, and the power terminals of the mating connector as viewed from the back, top, left side.

FIG. 11A is perspective view of the body of the mating connector as viewed from the front, bottom, left side.

FIG. 11B is a perspective view of the body of the mating connector as viewed from the back, top, and left side.

FIG. 12A is a perspective view of the signal terminals and the power terminals of the mating connector as viewed from the front, the bottom, and the left side.

FIG. 12B is a perspective view of the signal terminals and the power terminals of the mating connector as viewed from the back, top, left side.

### DESCRIPTION OF EMBODIMENTS

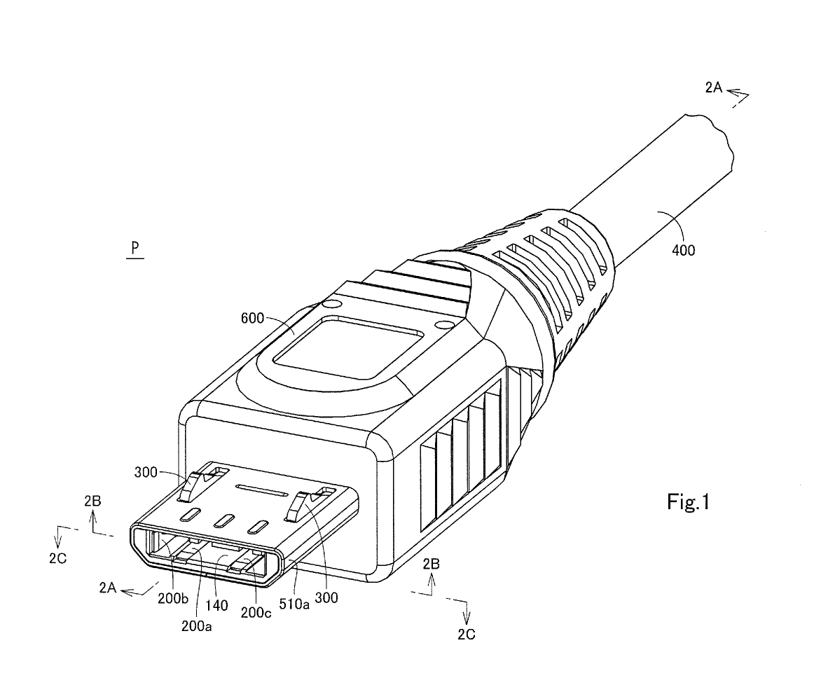

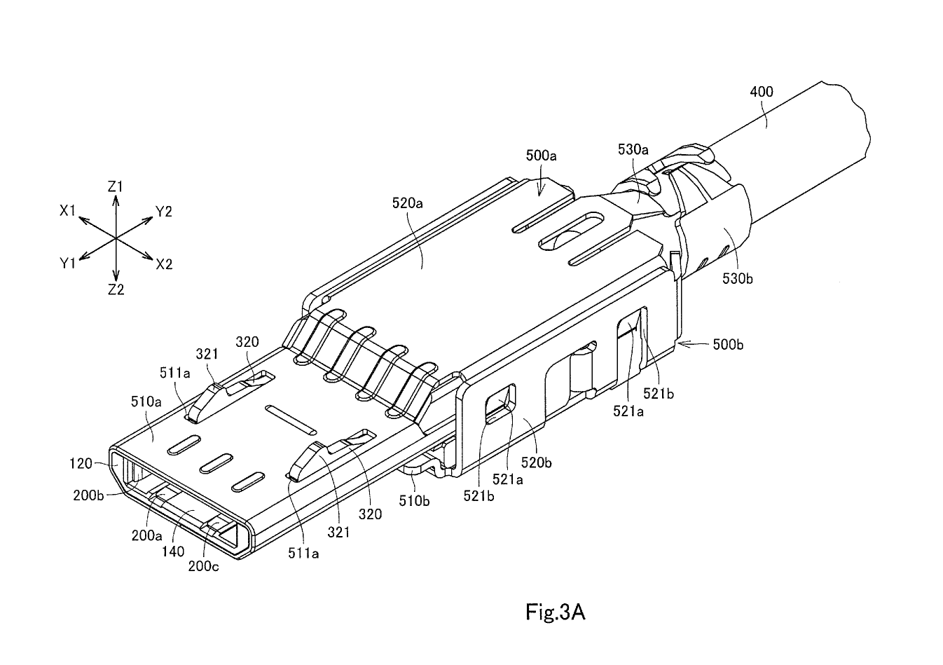

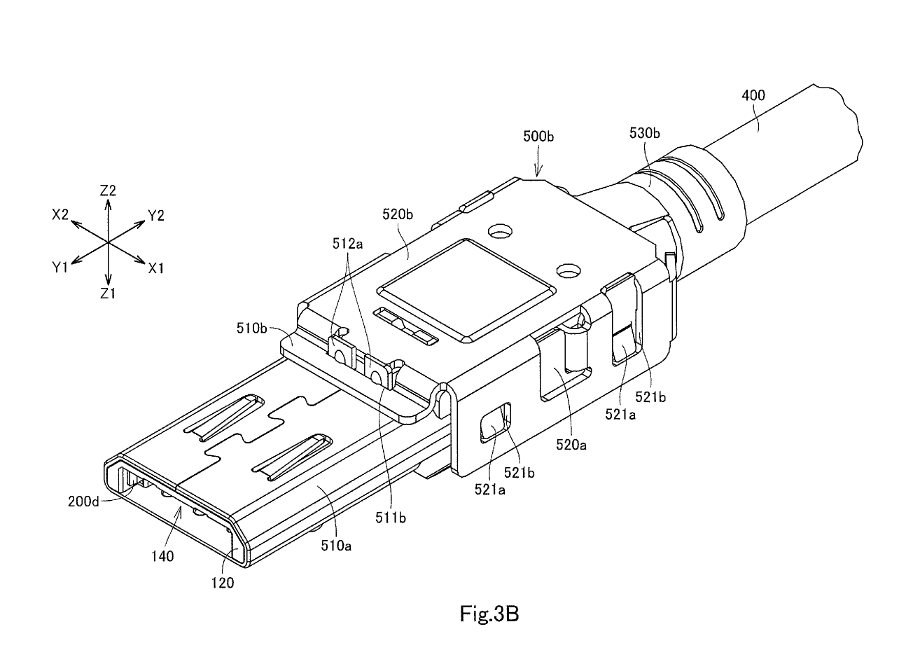

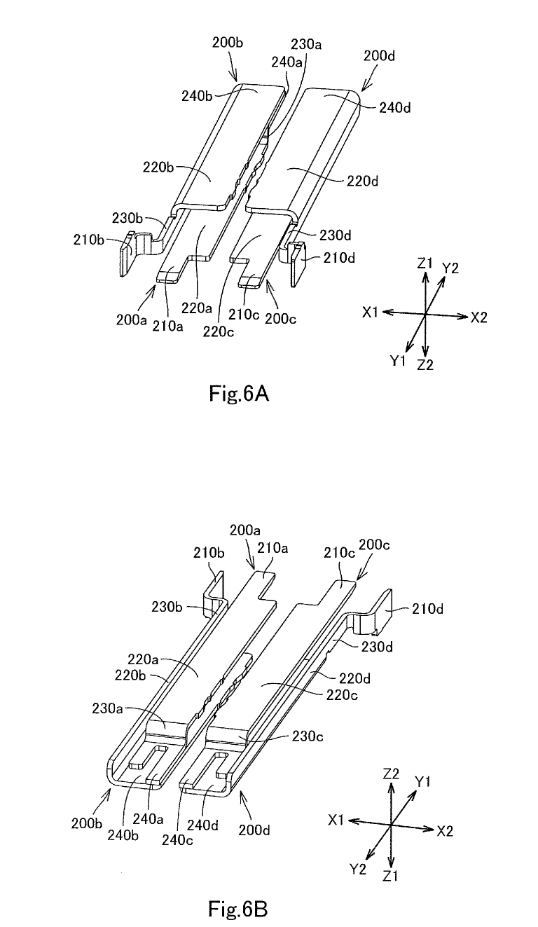

A connector P in accordance with an embodiment of the invention will be described with reference to FIG. 1 to FIG. 7B. The connector P is a plug connector. The connector P includes a body 100, first, second, third, and fourth terminals 200a, 200b, 200c, and 200d, a pair of lock pieces 300, a cable 400, shield cases 500a and 500b, a case 600, and an insulating tape 700. These constituents of the connector P will be described below in detail. X1 shown in FIG. 3A to FIG. 7B represents a widthwise direction of the connector P, and X2 represents the other widthwise direction of the connector P. Y1 represents a lengthwise direction of the connector P, and Y2 represents the other lengthwise direction of the connector P. Z1 represents a heightwise direction of the connector P, and Z2 represents the other heightwise direction of the connector P. The Y1-Y2 direction is orthogonal to the X1-X2 direction, and the Z1-Z2 direction is orthogonal to the X1-X2 direction and the Y1-Y2 direction.

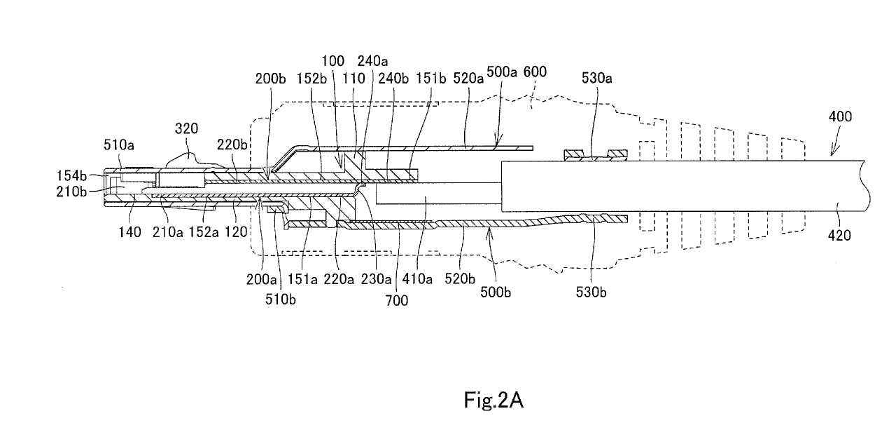

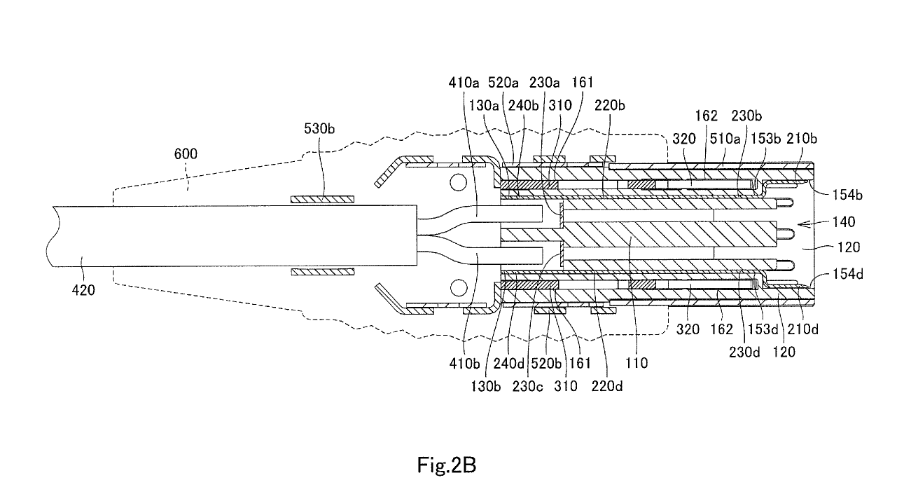

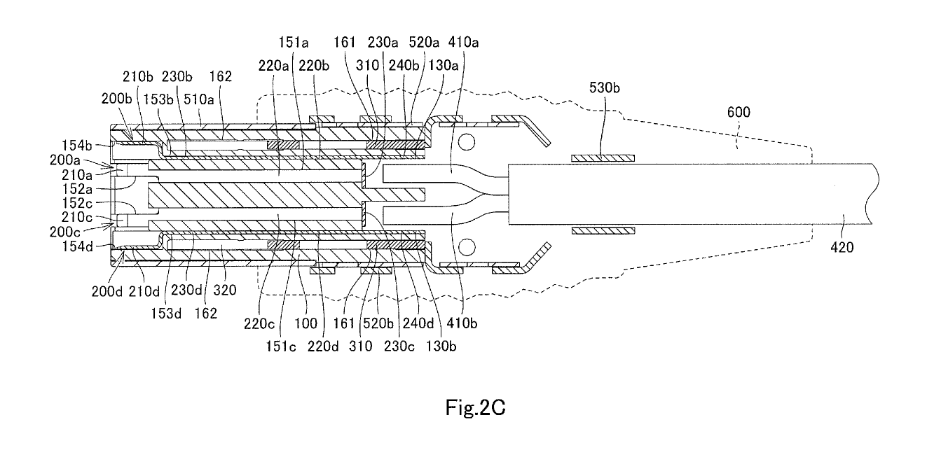

The body 100 as shown in FIGS. 2A to 2C and 4A to 5B is made of insulating resin. The body 100 includes a base 110, a protruding part 120, first and second recesses 130a and 130b, a connection part 140, housing parts 150a, 150b, 150c, and 150d, and a pair of housing parts 160.

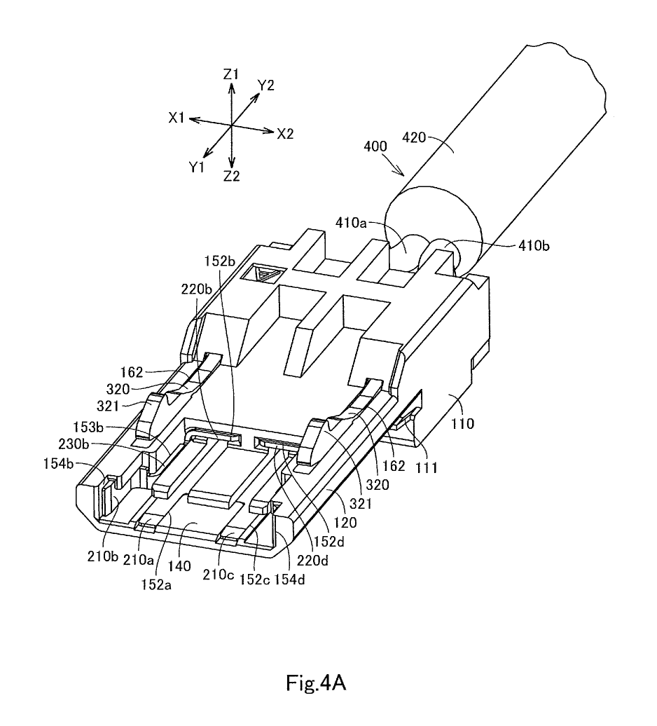

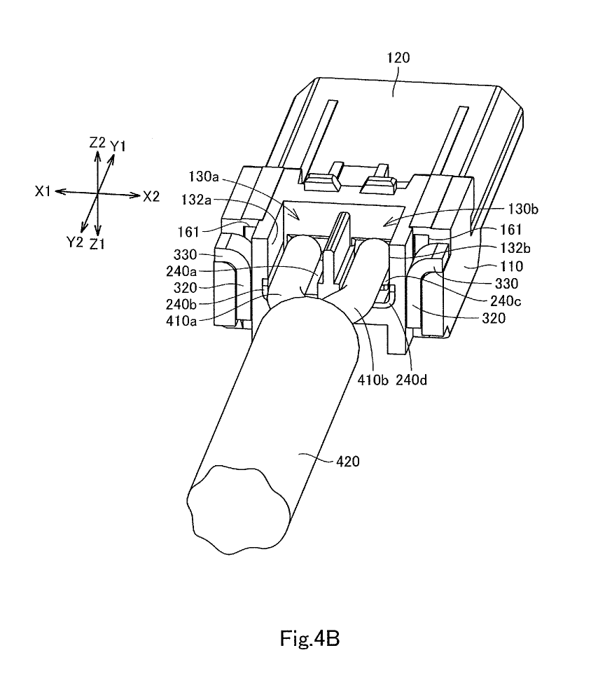

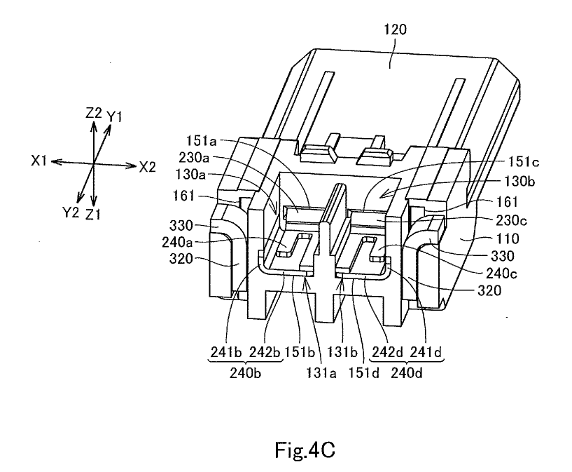

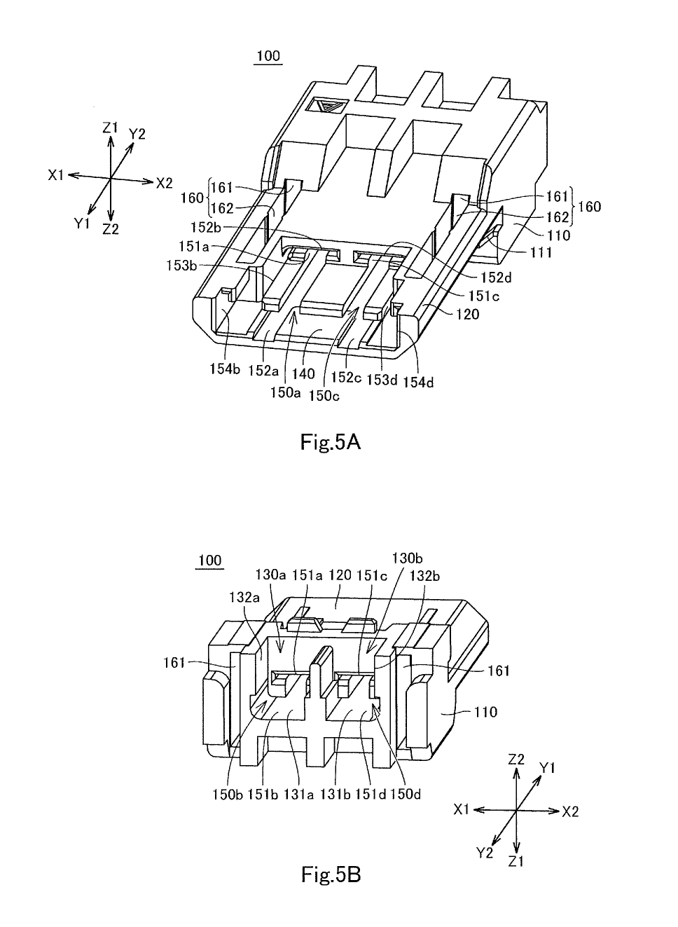

The base 110 is a block made of insulating resin. As shown in FIG. 4A and FIG. 5A, the base 110 is provided with two recesses aligned in the X1-X2 direction, in the Z1 direction portion (upper portion) of the Y2-direction end of the base 110 (the Y2-direction end (rear end) of the body 100).

As shown in FIG. 4B, FIG. 4C, and FIG. 5B, the first and second recesses 130a and 130b align in the X1-X2 direction, in the Z2 direction portion (lower portion) of the Y2-direction end of the base 110. The first and second recesses 130a and 130b are generally rectangular recesses opening in the Y2 and Z2 directions. The first recess 130a has a first bottom 131a and a first side wall 132a substantially perpendicular to the first bottom 131a. The first side wall 132a is a wall in the X1 direction (on the outer side) of the first recess 130a. The second recess 130b has a second bottom 131b and a second side wall 132b substantially perpendicular to the second bottom 131b. The second side wall 132b is a wall in the X2 direction (on the outer side) of the second recess 130b. As shown in FIG. 2A, the insulating tape 700 covers the first and second recesses 130a and 130b.

As shown in FIG. 4A to FIG. 5B, the protruding part 120 extends from the Z1-Z2 direction center of the Y1-direction end of the base 110. The protruding part 120 is an insulating resin plate. Generally U-shaped slits 111 are provided at the Y1-direction end of the base 110, on the Z2-direction side of the protruding part 120.

The Y1-direction end portion of the protruding part 120 includes the connection part 140. The connection part 140 is a recess opening in the Y1 direction (to the front side) and the Z1 direction (to the upper side).

The housing part 150a serves to house the first terminal 200a and has an engaging hole 151a and a groove 152a as shown in FIG. 5A and FIG. 5B. The engaging hole 151a has a rectangular cross section, extending from the wall on the Y1-direction side of the first recess 130a to the wall on the Y2-direction side of the connection part 140. The groove 152a is provided in the bottom of the connection part 140 and communicates with the engaging hole 151a. The groove 152a extends in the Y1 direction.

The housing part 150c serves to house the third terminal 200c and is symmetric to the housing part 150a as shown in FIG. 5A and FIG. 5B. The housing part 150c has an engaging hole 151c and a groove 152c. The engaging hole 151c is has a rectangular cross section, extending from the wall on the Y1-direction side of the second recess 130b to the wall on the Y2-direction side of the connection part 140. The groove 152c is provided in the bottom of the connection part 140 and communicates with the engaging hole 151c. The groove 152c extends in the Y1 direction.

The housing part 150b serves to house the second terminal 200b and is located on the Z1-direction side (upper side) of the housing part 150a as shown in FIG. 5A and FIG. 5B. The housing part 150b includes an L-shaped recess 151b, an engaging hole 152b, a slit 153b, and a housing recess 154b. The L-shaped recess 151b is generally L-shaped in the X1-X2 direction cross section, provided in the first bottom 131a and the first side wall 132a of the first recess 130a of the base 110. The L-shaped recess 151b consists of a bottom region and a side region. The bottom region is provided in the first bottom 131a. The side region is provided in the first side wall 132a and communicates with the bottom region. The engaging hole 152b is generally L-shaped in the X1-X2 direction cross section, extending from the wall on the Y1-direction side of the first recess 130a to the wall on the Y2-direction side of the connection part 140. The engaging hole 152b communicates with the L-shaped recess 151b. As shown in FIG. 2A, FIG. 4C, and FIG. 5A, the engaging hole 152b is located on the Z1-direction side (upper side) of the engaging hole 151a of the housing part 150a. The engaging hole 152b and the engaging hole 151a communicate with each other through a rectangular communicating hole. The engaging hole 152b consists of a horizontal portion and a vertical portion. As shown in FIG. 4A and FIG. 5A, the slit 153b is provided in a bottom of the connection part 140 and communicates with the vertical portion of the engaging hole 152b. The slit 153b extends in the Y1 direction. The slit 153b is located on the X1-direction side of the groove 152a. The housing recess 154b is provided in the side wall on the Y1-direction side of the connection part 140.

The housing part 150d serves to house the fourth terminal 200d, and as shown in FIG. 5A and FIG. 5B, it is symmetric to the housing part 150b and is located on the Z1-direction side (upper side) of the housing part 150c. The housing part 150d includes an L-shaped recess 151d, an engaging hole 152d, a slit 153d, and a housing recess 154d. The L-shaped recess 151d is generally L-shaped in the X1-X2 direction cross section, provided in the second bottom 131b and the second side wall 132b of the second recess 130b of the base 110. The L-shaped recess 151d consists of a bottom region and a side region. The bottom region is provided in the second bottom 131b. The side region is provided in the second side wall 132b and communicates with the bottom region. The engaging hole 152d generally L-shaped in the X1-X2 direction cross section, extending from the wall on the Y1-direction side of the second recess 130b to the wall on the Y2-direction side of the connection part 140. The engaging hole 152d communicates with the L-shaped recess 151d. As shown in FIG. 4C and FIG. 5A, the engaging hole 152d is located on the Z1-direction side (upper side) of the engaging hole 151c of the housing part 150c. The engaging hole 152d and the engaging hole 151c communicate with each other through a rectangular communicating hole. The engaging hole 152d consists of a horizontal portion and a vertical portion. As shown in FIG. 4A and FIG. 5A, the slit 153d is provided in a bottom of the connection part 140 and communicates with the vertical portion of the engaging hole 152d. The slit 153d extends in the Y1 direction. The slit 153d is located on the X2-direction side of the groove 152c. The housing recess 154d is provided in the side wall on the X2-direction side of the connection part 140.

The housing parts 160 serve to house the lock pieces 300 and each have an engaging hole 161 and a slit 162 as shown in FIG. 2B, FIG. 2C and FIG. 5A to FIG. 5B. The engaging holes 161 extend from the end face on the Y2 direction of the base 110 to the end face on the Y1 direction of the base 110. One of the engaging holes 161 is located on the X1-direction side of the first recess 130a, the engaging hole 151a of the housing part 150a, and the engaging hole 152b of the housing part 150b. The other engaging hole 161 is located on the X2-direction side of the second recess 130b, the engaging hole 151c of the housing part 150c, and the engaging hole 152d of the housing part 150d. The slits 162 of the housing parts 160 are provided near the X1 and X2 ends, respectively, of the protruding part 120 and communicate with the respective engaging holes 161. The slits 162 extend in the Y1 direction and open in the Z1 direction. One of the slits 162 is located on the X1-direction side of the engaging hole 151a of the housing part 150a, the engaging hole 152b of the housing part 150b, and the connection part 140. The other slit 162 is located on the X2-direction side of the engaging hole 151c of the housing part 150c, the engaging hole 152d of the housing part 150d, and the connection part 140.

The first terminal 200a is a positive (Vcc) power terminal held by the body 100 as shown in FIGS. 2A to 2C, 4A to 4C, and 6A to 6B. The first terminal 200a is formed of a metal plate. The first terminal 200a includes a first contact portion 210a, a first engaging portion 220a, a first bent portion 230a, and a first connecting portion 240a.

The first engaging portion 220a is a rectangular metal plate extending in the Y1-Y2 direction. The first engaging portion 220a is received in and engaged with the engaging hole 151a of the housing part 150a of the body 100. The first contact portion 210a is a generally L-shaped metal plate contiguous with the Y1-direction end of the first engaging portion 220a. The first contact portion 210a is received in the groove 152a of the housing part 150a and partially exposed from the groove 152a to the connection part 140. The first bent portion 230a is a metal plate contiguous with the Y2-direction end of the first engaging portion 220a and is bent in the Z1 direction. The first bent portion 230a is housed in the first recess 130a of the body 100. The first connecting portion 240a is a metal plate contiguous with the first bent portion 230a and extends in the Y2 direction. The first connecting portion 240a is disposed on the first bottom 131a of the first recess 130a. The first connecting portion 240a has X1- and X2-direction end portions. The middle area between the X1- and X2-direction end portions of the first connecting portion 240a is cut-out (hereinafter referred to as first cut-out). The X1-direction end portion is cut away at its Y2-direction end such that the X1-direction end portion is smaller in length in the Y1-Y2 direction than the X2-direction end portion (hereinafter referred to as second cut-out).

The third terminal 200c is a negative (GND) power terminal held by the body 100 as shown in FIGS. 2B to 2C, 4A to 4C, and 6A to 6B. The third terminal 200c is formed of a metal plate. The third terminal 200c is symmetric to the first terminal 200a, only the differences between them will be described. The third terminal 200c includes a third engaging portion 220c received in and engaged with the engaging hole 151c of the housing part 150c of the body 100. The third terminal 200c includes a third contact portion 210c received in the groove 152c of the housing part 150c and partially exposed from the groove 152c to the connection part 140. The third terminal 200c includes a third bent portion 230c housed in the second recess 130b of the body 100. The third terminal 200c includes a third connecting portion 240c disposed on the second bottom 131b of the second recess 130b. The third connecting portion 240c has X1- and X2-direction end portions. The middle area between the X1- and X2-direction end portions of the third connecting portion 240c is cut-out (hereinafter referred to as first cut-out). The X2-direction end portion is cut away at its Y2-direction end such that the X2-direction end portion is smaller in length in the Y1-Y2 direction than the X1-direction end portion (hereinafter referred to as second cut-out).

The second terminal 200b is a positive (Vcc) power terminal held by the body 100 as shown in FIGS. 2A to 2C, 4A to 4C, and 6A to 6B. The second terminal 200b is formed of a metal plate. The second terminal 200b has a second contact portion 210b, a second engaging portion 220b, a second extended portion 230b, and a second connecting portion 240b.

The second engaging portion 220b is a metal plate extending in the Y1-Y2 direction and has a generally L-shaped cross section in the X1-X2 direction. The second engaging portion 220b is received in and engaged with the engaging hole 152b of the housing part 150b of the body 100. The second engaging portion 220b consists of a horizontal portion and a vertical portion. The second extended portion 230b is a metal plate of generally L-shaped cross section in the Y1-Y2 direction and contiguous with the Y1-direction end of the vertical portion of the second engaging portion 220b. The second extended portion 230b consists of a first portion extending in the Y1 direction and a second portion bent substantially perpendicular to the first portion. The first portion of the second extended portion 230b is received in the slit 153b of the housing part 150b. The second portion of the second extended portion 230b is disposed along the wall on the Y2-direction side of the housing recess 154b of the housing part 150b. The second contact portion 210b is a metal plate contiguous with the second portion of the second extended portion 230b. The second contact portion 210b is disposed along the wall on the X1-direction side of the housing recess 154b of the housing part 150b. As described above, the first and second contact portions 210a and 210b are exposed from different places (groove 152a of the housing part 150a and the housing recess 154b of the housing part 150b, respectively) of the connection part 140.

The second connecting portion 240b is a metal plate having a generally L-shaped cross section in the X1-X2 direction and, contiguous with the Y2-direction end of the second engaging portion 220b. The second connecting portion 240b consists of a first portion 241b and a second portion 242b. The first portion 241b is housed in the side region of the L-shaped recess 151b in the first recess 130a. In other words, the first portion 241b is provided in the first side wall 132a of the first recess 130a so as to be exposed from the first side wall 132a. The second portion 242b is a metal plate contiguous with the Z2-direction end of the first portion 241b and bent substantially perpendicular to the first portion 241b. The second portion 242b is housed in the bottom region of the L-shaped recess 151b of the first recess 130a. In other words, the second portion 242b is provided in the first bottom 131a of the first recess 130a so as to be exposed from the first bottom 131a. The second portion 242b is located under and in contact with the first connecting portion 240a of the first terminal 200a. The second portion 242b is exposed from the first and second cut-outs of the first connecting portion 240a. It should be noted that the first connecting portion 240a has smaller outer dimensions than the second portion 242b.

The fourth terminal 200d is a negative (GND) power terminal held by the body 100 as shown in FIGS. 2B to 2C, 4A to 4C, and 6A to 6B. The fourth terminal 200d is formed of a metal plate. Since the fourth terminal 200d is symmetric to the second terminal 200b, only the differences between them will be described below. The fourth terminal 200d includes a fourth engaging portion 220d received in and engaged with the engaging hole 152d of the housing part 150d of the body 100. The fourth terminal 200d includes a fourth extended portion 230d consisting of first and second portions. The first portion is received in the slit 153d of the housing part 150d, and the second portion is disposed along the wall on the Y2-direction side of the housing recess 154d of the housing part 150d.

Also, the fourth terminal 200d includes a fourth contact portion 210d disposed along the wall on the X2-direction side of the housing recess 154d of the housing part 150d. As described above, the third and fourth contact portions 210c and 210d are exposed from different places (the groove 152c of the housing part 150c and the housing recess 154d of the housing part 150d, respectively) of the connection part 140. The fourth connecting portion 240d of the fourth terminal 200d consists of a first portion 241d and a second portion 242d. The first portion 241d is housed in the side region of the L-shaped recess 151d in the second recess 130b. In other words, the first portion 241d is provided in the second side wall 132b of the second recess 130b so as to be exposed from the second side wall 132b. The second portion 242d of the fourth connecting portion 240d is housed in the bottom region of the L-shaped recess 151d of the second recess 130b. In other words, the second portion 242d is provided in the second bottom 131b of the second recess 130b so as to be exposed from the second bottom 131b. The second portion 242d is located under and in contact with the third connecting portion 240c of the third terminal 200c. The second portion 242d is exposed from the first and second cut-outs of the third connecting portion 240c. It should be noted that the third connecting portion 240c has smaller outer dimensions than the second portion 242d.

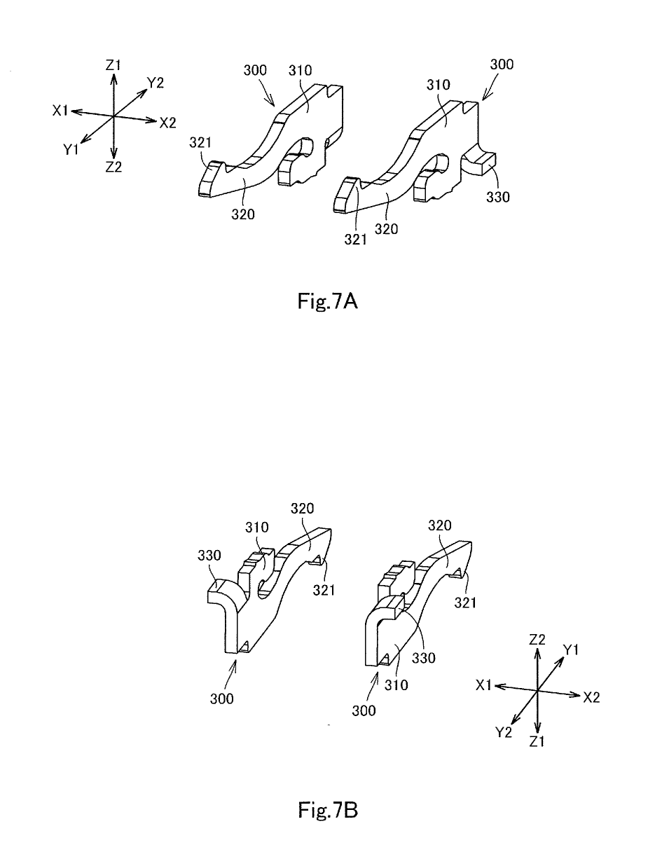

As shown in FIG. 7A to FIG. 7B, the lock pieces 300 each have a fixing portion 310, an arm 320, and an abutting portion 330. The fixing portions 310 each are generally C-shaped plates. As shown in FIGS. 2B to 2C and 4B to 4C, the fixing portions 310 are received in and engaged with the associated engaging holes 161 of the housing parts 160 of the body 100. The fixing portions 310 each have two Y1-direction end portions and an Y2-direction end portion. Each arm 320 is contiguous with one of the Y1-direction end portions (one on the Z1-direction side) of each fixing portion 310 and extends in the Y1 direction. The front end of each arm 320 is provided with a claw 321 projecting in the Z1 direction. As shown in FIG. 4A, the arms 320 are housed in the respective slits 162 of the housing parts 160, allowing the claws 321 to protrude from the slits 162 in the Z1 direction. The arms 320 are elastically deformable in the Z2 direction. Elastic deformation of the arms 320 make the claws 321 be received in the respective slits 162. The abutting portions 330 are plates formed by cutting and bending Z2 direction portions (lower portions) of the Y2-direction end portions of the fixing portion 310. The abutting portions 330 abut the body 100 to position the fixing portions 310 and the arms 320 in the housing parts 160.

As shown in FIG. 2A to FIG. 4B, the cable 400 has first and second core wires 410a and 410b (first and second connection objects) and an insulator 420. The insulator 420 is a cylinder that covers the first and second core wires 410a and 410b. The first core wire 410a is on the positive side (Vcc side). The second core wire 410b is on the negative side (GND side). A lengthwise end of each of the first and second core wires 410a and 410b protrudes from the insulator 420. The one end of the first core wire 410a is received in the first recess 130a of the body 100 and soldered to the first connecting portion 240a of the first terminal 200a and the second connecting portion 240b (the first and second portions 241b and 242b) of the second terminal 200b. The one end of the second core wire 410b is received in the second recess 130b of the body 100 and soldered to the third connecting portion 240c of the third terminal 200c and the fourth connecting portion 240d (the first and second portions 241d and 242d) of the fourth terminal 200d. The other lengthwise end of each of the first and second core wires 410a and 410b are connectable to an adaptor not shown. The first and second core wires 410a and 410b are connectable to the power source via the adaptor.

The shield case 500a as shown in FIG. 2A to FIG. 3B is formed of a metal plate. The shield case 500a includes a tube 510a, a cup 520a, and a cable holder 530a. The cup 520a has a generally inverted U-shaped cross section. The cup 520a is placed over the base 110 from the Z1 direction. The X1- and X2-direction ends of the cup 520a are provided with a plurality of engaging pieces 521a.

The tube 510a is contiguous with the Y1-direction end of the cup 520a. The inner shape of the tube 510a conforms to the outer shape of the protruding part 120 of the body 100. The tube 510a fits around the protruding part 120. The tube 510a covers the openings in the Z1 direction of the connection part 140 of the protruding part 120, the housing recess 154b and the housing recess 154d. The tube 510a, the connection part 140, the housing recess 154b, and the housing recess 154d define a connection hole of the connector P. The plate on the Z1-direction side (upper plate) of the tube 510a is provided with a pair of openings 511a at positions corresponding to the slits 162 of the body 100. The openings 511a let through the claws 321 of the arms 320 of the lock pieces 300. The plate on the Z2-direction side (lower plate) of the tube 510a is provided with a pair of engaging pieces 512a.

The cable holder 530a is a plate contiguous with the Y2-direction end of the cup 520a and extends in the Y2 direction. The distal portion of the cable holder 530a abuts the insulator 420 of the cable 400.

The shield case 500b as shown in FIG. 2A to FIG. 3B is formed of a metal plate. The shield case 500b has a tongue 510b, a cup 520b, and a cable holder 530b. The cup 520b has a generally U-shaped cross section. The cup 520b is placed over the base 110 and the cup 520a from the Z2 direction. That is, the cups 520a and 520b surround the outer circumference of the base 110. The X1- and X2-direction ends of the cup 520b are provided with a plurality of engaging holes 521b. The engaging holes 521b of the cup 520b are engaged with the engaging pieces 521a of the cup 520a. The cup 520b contacts the insulating tape 700, which closes the first and second recesses 130a and 130b. The insulating tape 700 insulates the cup 520b from the solder in the first and second recesses 130a and 130b, preventing short-circuit therebetween. As described above, the solder in the first recess 130a connects the first core wire 410a to the first connecting portion 240a of the first terminal 200a and to the second connecting portion 240b of the second terminal 200b. The solder in the second recess 130b connects the second core wire 410b to the third connecting portion 240c of the third terminal 200c and to the fourth connecting portion 240d of the fourth terminal 200d.

The tongue 510b is contiguous with the Y1-direction end of the cup 520b. As shown in FIG. 3B, the tongue 510b has a slit 511b. The slit 511b is engaged with the engaging pieces 512a of the tube 510a.

The cable holder 530b is a plate contiguous with the Y2-direction end of the cup 520b and extends in the Y2 direction. The distal portion of the cable holder 530b is curved like a ring to hold the distal portion of the cable holder 530a and the insulator 420 of the cable 400.

The case 600 as shown in FIG. 1 is made of insulating resin and covers the base 110 of the body 100, the cup 520a and the cable holder 530a of the shield case 500a, the shield case 500b, and one lengthwise end of the cable 400. In other words, the tube 510a of the shield case 500a and the protruding part 120 of the body 100 protrude from the case 600 in the Y1 direction. The remaining portion of the cable 400 is led out of the case 600 to the Y2 direction.

The connector P may be assembled in the following manner. First, the body 100 and the second and fourth terminals 200b and 200d are prepared. The second connecting portion 240b and the second engaging portion 220b of the second terminal 200b are inserted into the engaging hole 152b of the body 100 from the Y1 direction. The inserted second connecting portion 240b fits into the L-shaped recess 151b of the first recess 130a of the body 100. The second connecting portion 240b is thus embedded in the first bottom 131a and the first side wall 132a of the first recess 130a and partially exposed from the first bottom 131a and the first side wall 132a. The inserted second engaging portion 220b is engaged with the engaging hole 152b. The second extended portion 230b of the second terminal 200b is received in the slit 153b of the body 100 and extends along the wall on the Y2-direction side of the housing recess 154b of the body 100. The second contact portion 210b of the second terminal 200b is disposed along the wall on the X1-direction side of the housing recess 154b. The second terminal 200b is thus held by the body 100.

Similarly, the fourth connecting portion 240d and the fourth engaging portion 220d of the fourth terminal 200d are inserted into the engaging hole 152d of the body 100 from the Y1 direction. The inserted fourth connecting portion 240d fits into the L-shaped recess 151d of the second recess 130b of the body 100. The fourth connecting portion 240d is thus embedded in the second bottom 131b and the second side wall 132b of the second recess 130b and partially exposed from the second bottom 131b and the second side wall 132b. The inserted fourth engaging portion 220d is engaged with the engaging hole 152d. The fourth extended portion 230d of the fourth terminal 200d is received in the slit 153d of the body 100 and extends along the wall on the Y2-direction side of the housing recess 154d of the body 100. The fourth contact portion 210d of the fourth terminal 200d is disposed along the wall on the X2-direction side of the housing recess 154d. The fourth terminal 200d is thus held by the body 100.

The first and third terminals 200a and 200c are also prepared. The first contact portion 210a and the first engaging portion 220a of the first terminal 200a are inserted into the engaging hole 151a of the body 100 from the Y2 direction. The inserted first contact portion 210a is received in the groove 152a of the body 100 and partially exposed to the connection part 140. The inserted first engaging portion 220a is engaged with the engaging hole 151a. The first bent portion 230a of the first terminal 200a is housed in the first recess 130a of the body 100. The first connecting portion 240a of the first terminal 200a is disposed on the second connecting portion 240b of the second terminal 200b in the first recess 130a to be brought into contact with the second portion 242b of the second connecting portion 240b. The second portion 242b is exposed from the first and second cut-outs of the first connecting portion 240a.

Similarly, the third contact portion 210c and the third engaging portion 220c of the third terminal 200c are inserted into the engaging hole 151c of the body 100 from the Y2 direction. The inserted third contact portion 210c is received in the groove 152c of the body 100, and is exposed to the connection part 140. The inserted third engaging portion 220c is engaged with the engaging hole 151c. The third bent portion 230c of the third terminal 200c is housed in the second recess 130b of the body 100. The third connecting portion 240c of the third terminal 200c is disposed on the fourth connecting portion 240d of the fourth terminal 200d in the second recess 130b to be brought into contact with the second portion 242d of the fourth connecting portion 240d. The second portion 242d is exposed from the first and second cut-outs of the third connecting portion 240c.

The cable 400 is also prepared. The first core wire 410a of the cable 400 is inserted into the first recess 130a of the body 100 to be brought into contact with the first and second connecting portions 240a and 240b. Similarly, the second core wire 410b of the cable 400 is inserted into the second recess 130b of the body 100 to be brought into contact with the third and fourth connecting portions 240c and 240d. In this state, the first core wire 410a is soldered to the first and second connecting portions 240a and 240b, and the second core wire 410b is soldered to the third and fourth connecting portions 240c and 240d.

The lock pieces 300 are also prepared. The arms 320 and the fixing portions 310 of the lock pieces 300 are inserted into the respective engaging holes 161 of the body 100. The inserted fixing portions 310 are brought into engagement with the engaging holes 161. The abutting portions 330 of the lock pieces 300 are brought into abutment with the body 100. The arms 320 are received in the respective slits 162 of the body 100, and the claws 321 of the arms 320 protrude from the respective slits 162 in the Z1 direction.

The shield cases 500a and 500b and the insulating tape 700 are also prepared. The cable holder 530b of the shield case 500b is a flat plate at this stage. Subsequently, the protruding part 120 of the body 100 is inserted into the tube 510a of the shield case 500a, and the cup 520a of the shield case 500a is placed over the base 110 of the body 100. At this stage, the cable holder 530a of the shield case 500a contacts the insulator 420 of the cable 400. The claws 321 of the lock pieces 300 are received in the respective openings 511a of the tube 510a.

Then, the insulating tape 700 is placed on the body 100 to close the first and second recesses 130a and 130b. After that, the engaging pieces 512a of the tube 510a is inserted into and brought into engagement with the slit 511b of the tongue 510b of the shield case 500b. Simultaneously, the cup 520b of the shield case 500b is placed over the cup 520a to engage the engaging pieces 521a of the cup 520a with the respective engaging holes 521b of the cup 520b. Also, the cup 520b contacts the insulating tape 700, and the cable holder 530b contacts the insulator 420 of the cable 400. The shield cases 500a and 500b are thus combined to cover the body 100. After that, the cable holder 530b is curved like a ring to hold the cable 400 and the cable holder 530a. The shield cases 500a and 500b thus hold the cable 400.

Subsequently, the base 110 of the body 100, the cup 520a of the shield case 500a, the cable holder 530a, the shield case 500b, and the lengthwise end of the cable 400 are placed into a die. Into the die, insulating resin is injected to mold the case 600. The case 600 thus covers the base 110 of the body 100, the cup 520a of the shield case 500a, the cable holder 530a, the shield case 500b, and the lengthwise end of the cable 400.

The connector P described above has at least the following technical features. First, the connector P will not be substantially upsized in accordance with the increase in outer diameter of the first and second core wires 410a and 410b for the purpose of supplying a large amount of power. This is realized through the following arrangement. The second connecting portion 240b is provided in the first bottom 131a and the first side wall 132a of the first recess 130a, and the first connecting portion 240a is provided on the second portion 242b of the second connecting portion 240b. The fourth connecting portion 240d is provided in the second bottom 131b and the second side wall 132b of the second recess 130b, and the third connecting portion 240c is provided on the second portion 242d of the fourth connecting portion 240d. The first core wire 410a is connected to the first and second connecting portions 240a and 240b together in the first recess 130a. The second core wire 410b is connected to the third and fourth connecting portions 240c and 240d together in the second recess 130b. This arrangement can reduce connection spaces (soldering spaces) for connecting between the first core wire 410a and the first and second connecting portions 240a and 240b and for connecting between the second core wire 410b and the third and fourth connecting portions 240c and 240d.

Second, the connector P has improved reliability of connection between the first core wire 410a and the first and second terminals 200a and 200b for the reasons below. The first portion 241b of the second connecting portion 240b is provided in the first side wall 132a of the first recess 130a, and the second portion 242b of the second connecting portion 240b is provided in the first bottom 131a of the first recess 130a. The second portion 242b is in contact with the first connecting portion 240a. The first connecting portion 240a has smaller outer dimensions than the second portion 242b, so that the second portion 242b is partially exposed outside the first connecting portion 240a. This arrangement can increase the area for connection between the first core wire 410a and the first and second connecting portions 240a and 240b. Therefore, connecting the first core wire 410a to at least one of the first and second connecting portions 240a and 240b will result in connection to both the connecting portions. Similarly, the connector P has an improved reliability of connection between the second core wire 410b and the third and fourth terminals 200c and 200d for the reasons below. The first portion 241d of the fourth connecting portion 240d is provided in the second side wall 132b of the second recess 130b, and the second portion 242d of the fourth connecting portion 240d is provided in the second bottom 131b of the second recess 130b. The second portion 242d is in contact with the third connecting portion 240c. The third connecting portion 240c has smaller outer dimensions than the second portion 242d, so that the second portion 242d is partially exposed outside the third connecting portion 240c. This arrangement can increase the area for connection between the second core wire 410b and the third and fourth connecting portions 240c and 240d. Therefore, connecting t the second core wire 410b to at least one of the third and fourth connecting portions 240c and 240d will result in connection to both the connecting portions.

Third, the connector P has an improved reliability of connection with respect to a mating connector R (to be described) for the reasons below. The first and third contact portions 210a and 210c of the first and third terminals 200a and 200c are respectively received in the grooves 152a and 152c in the bottom of the connection part 140. The second contact portion 210b of the second terminal 200b is disposed along the wall on the X1-direction side of the housing recess 154b of the connection part 140. The fourth contact portion 210d of the fourth terminal 200d is disposed along the wall on the X2-direction side of the housing recess 154d of the connection part 140. This means that the first and third contact portions 210a and 210c, and the second and fourth contact portions 210b and 210d are exposed from different places of the connection part 140. Therefore, even if the connector P is pried with its connection hole engaged with the mating connector R, it is still possible to maintain the electrical connection of the mating connector R to at least one of the first and second contact portions 210a and 210b and to at least one of the third and fourth contact portions 210c and 210d.

Fourth, the connector P can be readily modified and therefore has improved versatility. One of the first and second terminals 200a and 200b can be omitted because the first core wire 410a is still connected to the other of the first and second terminals 200a and 200b in the first recess 130a. One of the third and fourth terminals 200c and 200d can be omitted because the second core wire 410b is still connected to the other of the third and fourth terminals 200c and 200d in the second recess 130b. It is thus easy to modify the connector P, simply by omitting one of the first and second terminals 200a and 200b and one of the third and fourth terminals 200c and 200d.

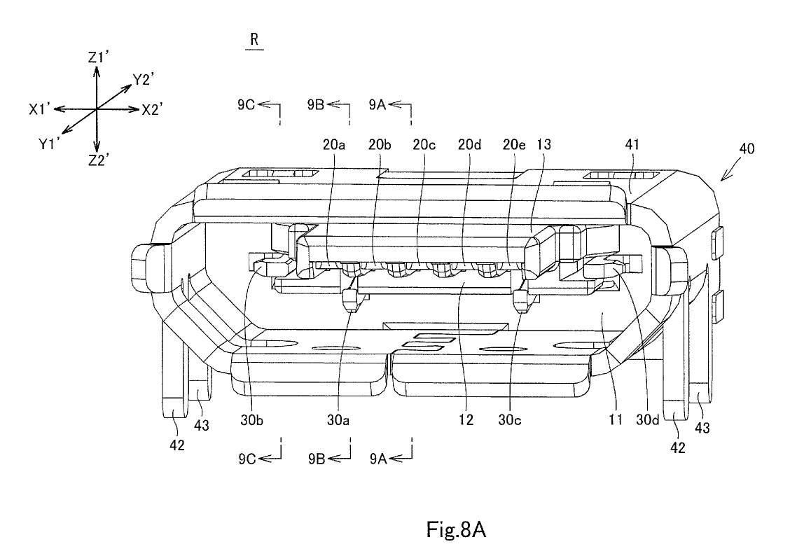

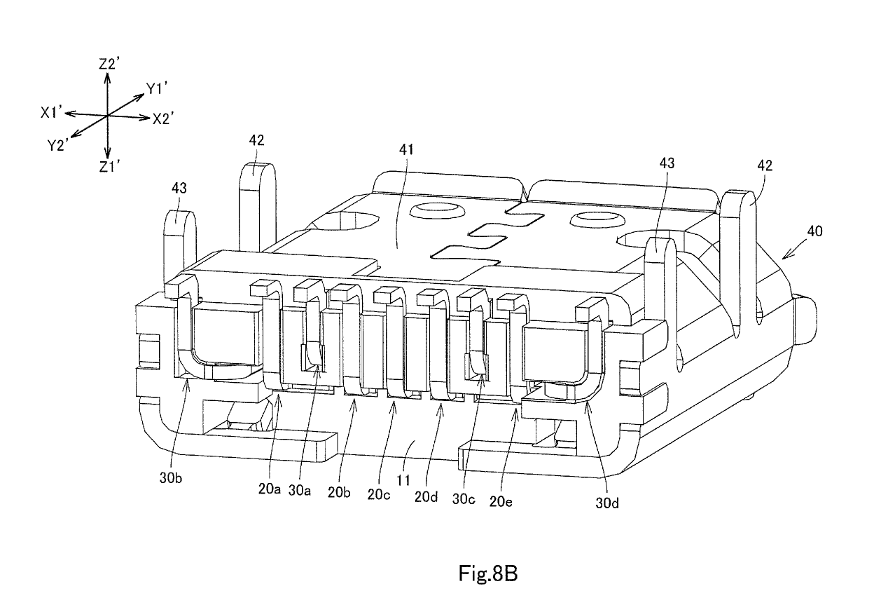

The mating connector R in accordance with an embodiment of the invention will be described below with reference to FIG. 8A to FIG. 12B. The mating connector R is a receptacle connector. The mating connector R includes a body 10, signal terminals 20a and 20b, a ground terminal 20c, signal terminals 20d and 20e, first, second, third, and fourth power terminals 30a, 30b, 30c, and 30d, and a shield case 40. These constituents of the mating connector R will be described below in detail. X1′ in FIG. 8A to FIG. 12B represents a widthwise direction of the mating connector R, and X2′ represents the other widthwise direction of the mating connector R. Y1′ represents a lengthwise direction of the mating connector R, and Y2′ represents the other lengthwise direction of the mating connector R. Z1′ represents a heightwise direction of the mating connector R, and Z2′ represents the other heightwise direction of the mating connector R. The Y1′-Y2′ direction is orthogonal to the X1′-X2′ direction, and the Z1′-Z2′ direction is orthogonal to the X1′-X2′ direction and the Y1′-Y2′ direction.

The body 10 as shown in FIG. 8A to FIG. 11B is made of insulating resin. The body 10 includes a base 11, a first protruding part 12, a second protruding part 13, housing portions 14a, 14b, 14c, 14d, and 14e, and housing portions 15a, 15b, 15c, and 15d.

As shown in FIG. 8A to FIG. 11B, the base 11 is a block made of insulating resin. The first protruding part 12 is an insulating resin block extending from the Z1′-Z2′ direction center of the Y1′-direction end of the base 11. The first protruding part 12 is smaller in the X1′-X2′ direction than the base 11, and the first protruding part 12 is smaller in the Z1′-Z2′ direction than the base 11. The second protruding part 13 is an insulating resin block provided at the Y1′-direction end of the first protruding part 12. The second protruding part 13 is smaller in the X1′-X2′ direction than the first protruding part 12, and the second protruding part 13 is smaller in the Z1′-Z2′ direction than the first protruding part 12. The first and second protruding parts 12 and 13 has outer shapes conforming to the connection hole of the connector P, so that the first and second protruding parts 12 and 13 can be removably received in the connection hole of the connector P.

The housing portion 14a has an engaging hole 14a1, a housing groove 14a2, and a housing groove 14a3. The housing portion 14b has an engaging hole 14b1, a housing groove 14b2, and a housing groove 14b3. The housing portion 14c has an engaging hole 14c1, a housing groove 14c2, and a housing groove 14c3. The housing portion 14d has an engaging hole 14d1, a housing groove 14d2, and a housing groove 14d3. The housing portion 14e has an engaging hole 14e1, a housing groove 14e2, and a housing groove 14e3.

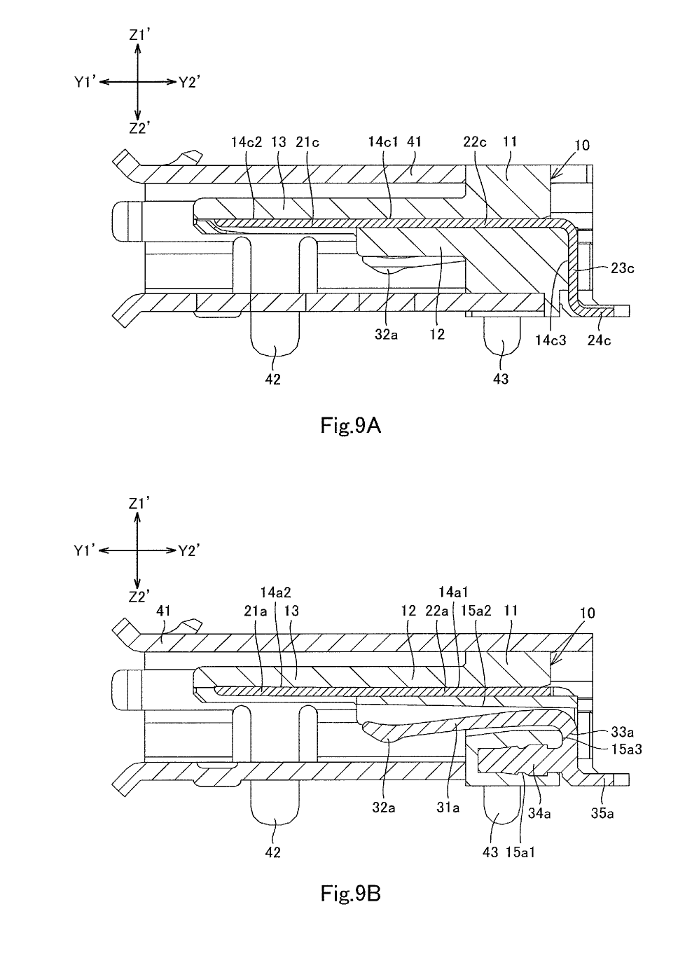

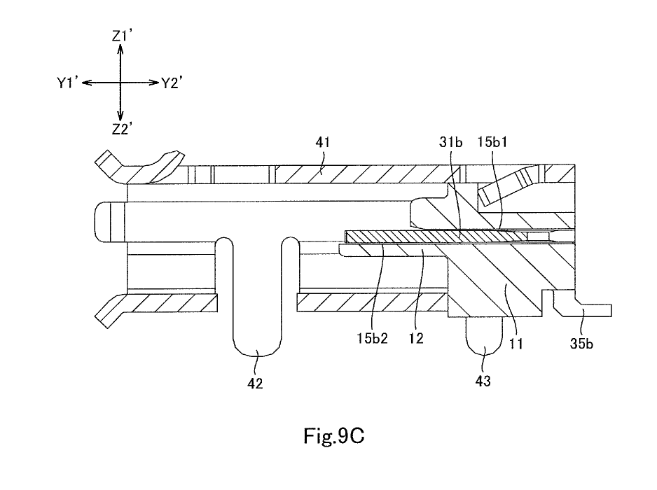

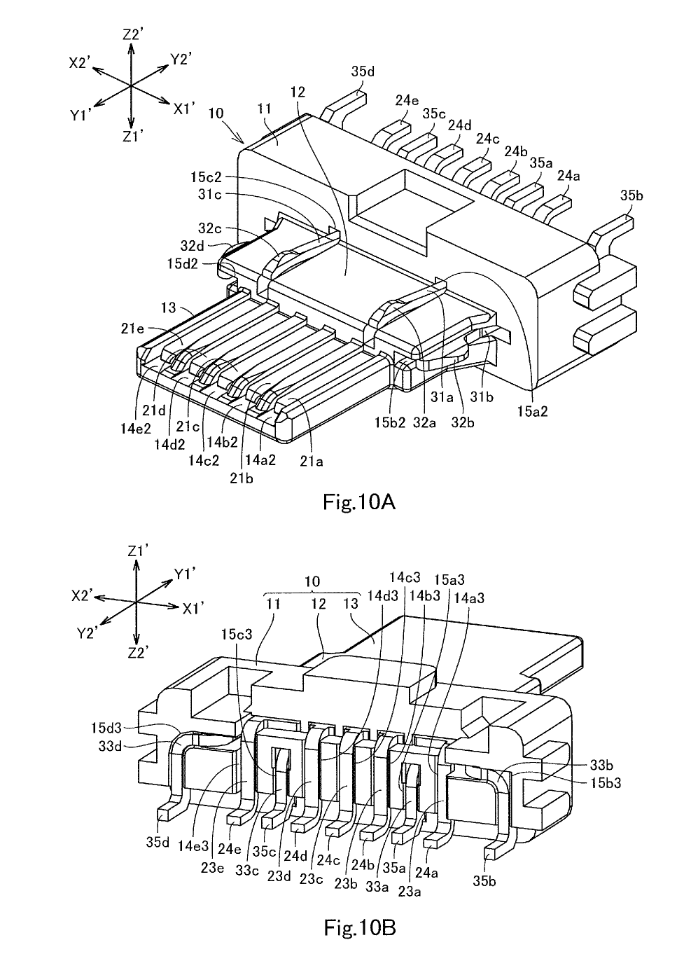

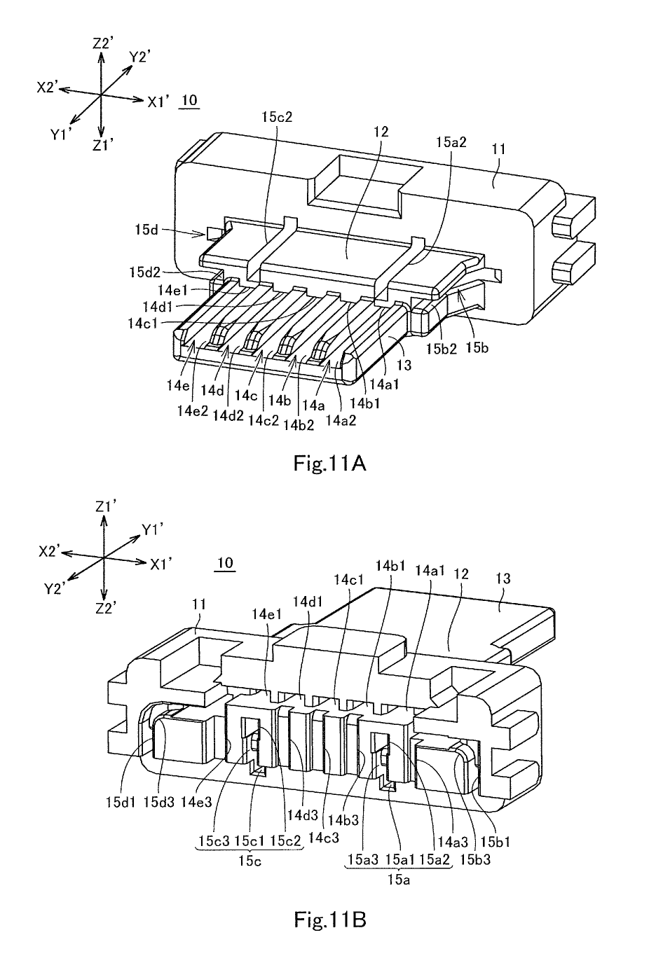

As shown in FIG. 10A to FIG. 11B, the engaging holes 14a1 to 14e1 are provided in the base 11 and the first protruding part 12 at intervals in the X1′-X2′ direction. The engaging hole 14a1 to 14e1 extend through the base 11 and the first protruding part 12 in the Y1′-Y2′ direction (see FIG. 9A and FIG. 9B). As shown in FIG. 10A and FIG. 11A, the housing grooves 14a2 to 14e2 are provided in the Z2′-direction end face of the second protruding part 13 at the same intervals in the X1′-X2′ direction as those of the engaging holes 14a1 to 14e1. The housing grooves 14a2 to 14e2 extend in the Y1′-Y2′ direction and communicate with the engaging hole 14a1 to 14e1, respectively. As shown in FIG. 11B, the housing grooves 14b3 to 14d3 are provided in the Y2′-direction end face of the base 11, at positions on the Z2′-direction side (on the lower side) of the engaging hole 14b1 to 14d1. The housing grooves 14b3 to 14d3 extend in the Z1′-Z2′ direction. The housing grooves 14a3 and 14e3 each consist of a horizontal groove extending in the X1′-X2′ direction and a vertical groove extending in the Z1′-Z2′ direction. The horizontal groove of the housing groove 14a3 communicates with the engaging hole 14a1, and the horizontal groove of the housing groove 14e3 communicates with the engaging hole 14e1. The vertical groove of the housing groove 14a3 communicates with the X1′-direction end of the horizontal groove of the housing groove 14a3. The vertical groove of the housing groove 14e3 communicates with the XT-direction end of the horizontal groove of the housing groove 14e3.

As shown in FIG. 9B and FIG. 10A to FIG. 11B, the housing portion 15a includes an engaging hole 15a1, a housing portion body 15a2, and a housing groove 15a3. The housing portion body 15a2 consists of a receiving hole and a receiving groove. The receiving hole of the housing portion body 15a2 is provided at a position of the base 11 substantially corresponding to the first contact portion 210c of the third terminal 200c of the connector P. The receiving hole of the housing portion body 15a2 is located on the Z2′-direction side than the engaging hole 14a1 of the housing portion 14a. As shown in FIG. 9B, the receiving hole of the housing portion body 15a2 extends through the base 11 in the Y1′-Y2′ direction. As shown in FIG. 9B, FIG. 10A, and FIG. 11A, the receiving groove of the housing portion body 15a2 is provided in the Z2′-direction end face of the first protruding part 12 and communicates with the receiving hole. The receiving groove of the housing portion body 15a2 extends in the Y1′-Y2′ direction. This means that the receiving groove of the housing portion body 15a2 is located at a position substantially corresponding to the first contact portion 210c of the third terminal 200c of the connector P. As shown in FIG. 9B and FIG. 11B, the engaging hole 15a1 is provided at a position of the base 11, on the Z2′-direction side of the receiving hole of the housing portion body 15a2. The engaging hole 15a1 extends in the Y1′-Y2′ direction. As shown in FIG. 9B, FIG. 10B, and FIG. 11B, the housing groove 15a3 is provided in the Y2′-direction end face of the base 11. The housing groove 15a3 is located between the vertical groove of the housing groove 14a3 of the housing portion 14a and the housing groove 14b3 of the housing portion 14b. The housing groove 15a3 extends in the Z1′-Z2′ direction and communicates with the receiving hole of the housing portion body 15a2 and the engaging hole 15a1.

As shown in FIG. 10A to FIG. 11B, the housing portion 15c has substantially the same shape as the housing portion 15a, but it is disposed at a different position as described below. A receiving hole of a housing portion body 15c2 of the housing portion 15c is provided at a position of the base 11 substantially corresponding to the first contact portion 210a of the first terminal 200a of the connector P. The receiving hole of the housing portion body 15c2 is located on the Z2′-direction side of the engaging hole 14e1 of the housing portion 14e. The receiving groove of the housing portion body 15c2 is provided in the Z2′-direction end face of the first protruding part 12 and communicates with the receiving hole. This means that the receiving groove of the housing portion body 15c2 is also located at a position substantially corresponding to the first contact portion 210a of the first terminal 200a. As shown in FIG. 11B, an engaging hole 15c1 of the housing portion 15c is provided at a position of the base 11, on the Z2′-direction side of the housing groove of the housing portion body 15c2. A housing groove 15c3 of the housing portion 15c is located between the vertical groove of the housing groove 14e3 of the housing portion 14e and the housing groove 14d3 of the housing portion 14d. The housing groove 15c3 of the housing portion 15c communicates with the receiving hole of the housing portion body 15c2 and the engaging hole 15c1.

As shown in FIG. 9C and FIG. 10A to FIG. 11B, the housing portion 15b includes an engaging hole 15b1, a housing portion body 15b2, and a housing groove 15b3. The housing portion body 15b2 has a receiving hole and a receiving groove. The receiving hole of the housing portion body 15b2 is provided in the base 11, located on the X1′-direction side of the first protruding part 12. The receiving hole of the housing portion body 15b2 extends through the base 11 in the Y1′-Y2′ direction. As shown in FIG. 10A and FIG. 11A, the receiving groove of the housing portion body 15b2 is provided in the X1′-direction end face of the first protruding part 12 and communicates with the receiving hole. The receiving groove of the housing portion body 15b2 extends in the Y1′-Y2′ direction. The receiving groove of the housing portion body 15b2 is located at a position substantially corresponding to the fourth contact portion 210d of the fourth terminal 200d. As shown in FIG. 10B and FIG. 11B, the housing groove 15b3 consists of a horizontal groove and a vertical groove. The horizontal groove communicates with the receiving hole of the housing portion body 15b2 and extends in the X1′ direction. The vertical groove communicates with the X1′-direction end of the horizontal groove and extends in the Z2′ direction. As shown in FIG. 11B, the engaging hole 15b1 extends in the Y1′ direction from the Z2′-direction end of the housing groove 15b3. The engaging hole 15b1 communicates with the housing groove 15b3.

As shown in FIG. 10A to FIG. 11B, since the housing portion 15d is symmetric to the housing portion 15b, only the differences between them will be described. A receiving hole of a housing portion body 15d2 is provided in the base 11, located on the X2′-direction side of the first protruding part 12. As shown in FIG. 10A and FIG. 11A, an receiving groove of the housing portion body 15d2 is provided in the X2′-direction end face of the first protruding part 12 and communicates with the receiving hole. The receiving groove of the housing portion body 15d2 is located at a position substantially corresponding to the second contact portion 210b of the second terminal 200b. As shown in FIG. 10B and FIG. 11B, a housing groove 15d3 consists of a horizontal groove and a vertical groove. The horizontal groove communicates with the receiving hole of the housing portion body 15d2 and extends in the X2′ direction. The vertical groove communicates with the X2′-direction end of the horizontal groove and extends in the Z2′ direction. As shown in FIG. 11B, an engaging hole 15d1 extends in the Y1′ direction from the Z2′-direction end of the housing groove 15d3. The engaging hole 15d1 communicates with the housing groove 15d3.

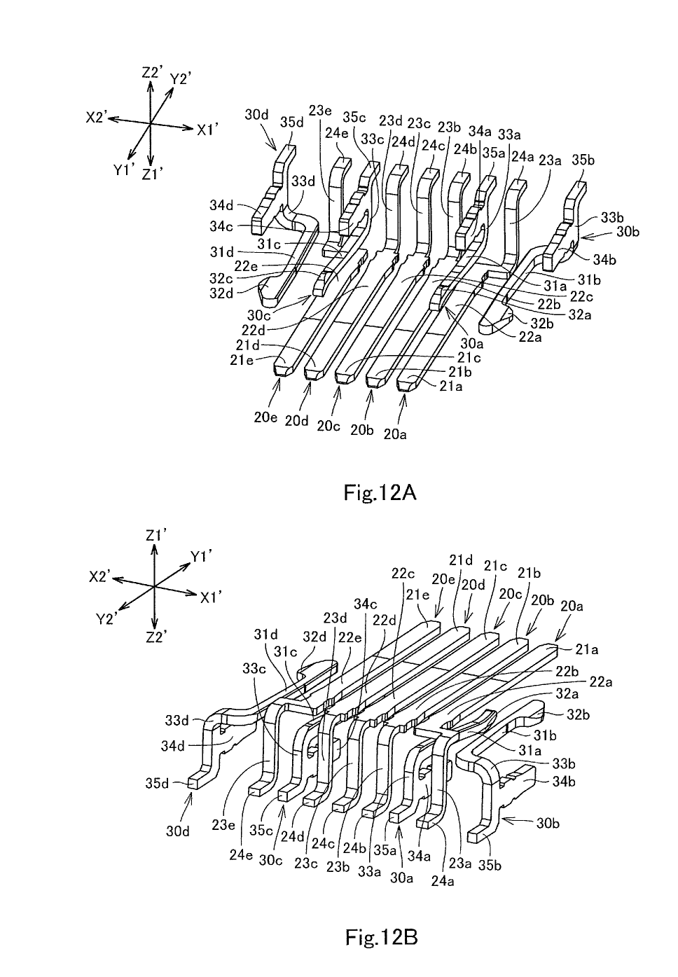

The signal terminal 20a as shown in FIG. 9B, FIG. 10A to FIG. 10B, and FIG. 12A to FIG. 12B is formed of a metal plate. The signal terminal 20a includes a contact portion 21a, an engaging portion 22a, an L-shaped portion 23a, and a tail portion 24a. The engaging portion 22a is a metal plate extending in the Y1′-Y2′ direction and is received in and engaged with the engaging hole 14a1 of the housing portion 14a. The contact portion 21a is a metal plate extending in the Y1′ direction from the Y1′-direction end of the engaging portion 22a. The contact portion 21a is received in the housing groove 14a2 of the housing portion 14a. The L-shaped portion 23a consists of a horizontal portion and a hanging portion. The horizontal portion is a metal plate extending in the X1′ direction from the Y2′-direction end of the engaging portion 22a. The horizontal portion is housed in the horizontal groove of the housing groove 14a3 of the housing portion 14a. The hanging portion is a metal plate extending in the Z2′ direction from the X1′-direction end of the horizontal portion. The hanging portion is housed in the vertical groove of the housing groove 14a3. The tail portion 24a is a metal plate extending in the Y2′ direction from the Z2′-direction end of the hanging portion.

The signal terminal 20e as shown in FIG. 10A to FIG. 10B and FIG. 12A to FIG. 12B is formed of a metal plate. Since the signal terminal 20e is symmetric to the signal terminal 20a, only the differences between them will be described. An engaging portion 22e of the signal terminal 20e is received in and engaged with the engaging hole 14e1 of the housing portion 14e. A contact portion 21e of the signal terminal 20e is received in the housing groove 14e2 of the housing portion 14e. A horizontal portion of an L-shaped portion 23e of the signal terminal 20e is a metal plate extending in the X2′ direction from the Y2′-direction end of the engaging portion 22e. The horizontal portion is housed in the horizontal groove of the housing groove 14e3 of the housing portion 14e. The hanging portion of the L-shaped portion 23e is a metal plate extending in the Z2′ direction from the X2′-direction end of the horizontal portion. The hanging portion is housed in the vertical groove of the housing groove 14e3. The signal terminal 20e also includes a tail portion 24e as illustrated in FIG. 10A to FIG. 10B and FIG. 12A to FIG. 12B.

The signal terminal 20b as shown in FIG. 10A to FIG. 10B and FIG. 12A to FIG. 12B is formed of a metal plate. The signal terminal 20b includes a contact portion 21b, an engaging portion 22b, a hanging portion 23b, and a tail portion 24b. The engaging portion 22b is a metal plate extending in the Y1′-Y2′ direction and is received in and engaged with the engaging hole 14b1 of the housing portion 14b. The contact portion 21b is a metal plate extending in the Y1′ direction from the Y1′-direction end of the engaging portion 22b. The contact portion 21b is received in the housing groove 14b2 of the housing portion 14b. The hanging portion 23b is a metal plate extending in the Z2′ direction from the Y2′-direction end of the engaging portion 22b. The hanging portion 23b is housed in the housing groove 14b3 of the housing portion 14b. The tail portion 24b is a metal plate extending in the Y2′ direction from the Z2′-direction end of the hanging portion 23b. It should be noted that the signal terminals 20a and 20b constitute a differential pair.

The signal terminal 20d as shown in FIG. 10A to FIG. 10B and FIG. 12A to FIG. 12B is formed of a metal plate. Since the signal terminal 20d is of the same shape as the signal terminal 20b, only the differences between them will be described. A engaging portion 22b of the signal terminal 20d is received in and engaged with the engaging hole 14d1 of the housing portion 14d. A contact portion 21d of the signal terminal 20d is received in the housing groove 14d2 of the housing portion 14d. A hanging portion 23d of the signal terminal 20d is housed in the housing groove 14d3 of the housing portion 14d. The signal terminal 20d also includes a tail portion 24d as illustrated in FIG. 10A to FIG. 10B and FIG. 12A to FIG. 12B. The signal terminals 20d and 20e constitute a differential pair.

The ground terminal 20c as shown in FIG. 9A and FIG. 12A to FIG. 12B is formed of a metal plate. Since the ground terminal 20c is of the same shape as the signal terminal 20b, only the differences between them will be described. An engaging portion 22c of the ground terminal 20c is received in and engaged with the engaging hole 14c1 of the housing portion 14c. A contact portion 21c of the ground terminal 20c is received in the housing groove 14c2 of the housing portion 14c. A hanging portion 23c of the ground terminal 20c is housed in the housing groove 14c3 of the housing portion 14c. The ground terminal 20c also includes a tail portion 24c as illustrated in FIG. 9A, FIG. 10B and FIG. 12A to FIG. 12B. The ground terminal 20c is disposed between the signal terminal 20b and the signal terminal 20d.

The first power terminal 30a is a positive (Vcc) power terminal as shown in FIG. 9B and FIG. 12A to FIG. 12B. The first power terminal 30a is formed of a metal plate. The first power terminal 30a includes a first arm 31a, a first contact portion 32a, a first hanging portion 33a, a first engaging portion 34a, and a first tail portion 35a. The first arm 31a is a metal plate extending in the Y1′-Y2′ direction. The first arm 31a is received in the housing portion body 15a2 of the housing portion 15a. The first contact portion 32a is a protrusion protruding in the Z2′ direction at the Y1′-direction end of the first arm 31a. The first contact portion 32a protrudes in the Z2′ direction out of the housing portion body 15a2 of the housing portion 15a. The first hanging portion 33a is a metal plate contiguous with the Y2′-direction end of the first arm 31a and extends in the Z2′ direction. The first hanging portion 33a is housed in the housing groove 15a3 of the housing portion 15a. The first engaging portion 34a is a metal plate extending in the Y1′ direction from the Z2′-direction end of the first hanging portion 33a. The first engaging portion 34a is received in and engaged with the engaging hole 15a1 of the housing portion 15a. The first tail portion 35a is a metal plate extending in the Y2′ direction from the Z2′-direction end of the first hanging portion 33a. The first hanging portion 33a is disposed between the hanging portion of the L-shaped portion 23a of the signal terminal 20a and the hanging portion 23b of the signal terminal 20b. The first tail portion 35a is disposed between the tail portion 24a of the signal terminal 20a and the tail portion 24b of the signal terminal 20b. With this arrangement, the first power terminal 30a reduces crosstalk between the signal terminal 20a and the signal terminal 20b.

The third power terminal 30c is a negative (GND) power terminal as shown in FIG. 12A to FIG. 12B. The third power terminal 30c is formed of a metal plate. Since the third power terminal 30c is of the same shape as the first power terminal 30a, only the differences between them will be described. A third arm 31c of the third power terminal 30c is received in the housing portion body 15c2 of the housing portion 15c. A third contact portion 32c of the third power terminal 30c protrudes in the Z2′ direction out of the housing portion body 15c2 of the housing portion 15c. A third hanging portion 33c of the third power terminal 30c is housed in the housing groove 15c3 of the housing portion 15c. A third engaging portion 34c of the third power terminal 30c is received in and engaged with the engaging hole 15c1 of the housing portion 15c. The third hanging portion 33c is disposed between the hanging portion of the L-shaped portion 23e of the signal terminal 20e and the hanging portion 23d of the signal terminal 20d. A third tail portion 35c of the third power terminal 30c is disposed between the tail portion 24e of the signal terminal 20e and the tail portion 24d of the signal terminal 20d. With this arrangement, the third power terminal 30c reduces crosstalk between the signal terminal 20d and the signal terminal 20e.

The second power terminal 30b is a positive (Vcc) power terminal as shown in FIG. 9C and FIG. 12A to FIG. 12B. The second power terminal 30b is formed of a metal plate. The second power terminal 30b includes a second arm 31b, a second contact portion 32b, a second L-shaped portion 33b, a second engaging portion 34b, and a second tail portion 35b. The second arm 31b is a metal plate extending in the Y1′-Y2′ direction. The second arm 31b is received in the housing portion body 15b2 of the housing portion 15b. The second contact portion 32b is a protrusion protruding in the X1′ direction at the Y1′-direction end of the second arm 31b. The second contact portion 32b protrudes in the X1′ direction out of the housing portion body 15b2 of the housing portion 15b. As described above, the first and second contact portions 32a and 32b are exposed from different places (from the housing portion bodies 15a2 and 15b2, respectively) of the first protruding part 12. The second L-shaped portion 33b consists of a horizontal portion and a hanging portion. The horizontal portion is a metal plate extending in the X1′ direction from the Y2′-direction end of the second arm 31b. The horizontal portion is housed in the horizontal groove of the housing groove 15b3. The hanging portion is a metal plate extending in the Z2′ direction from the X1′-direction end of the horizontal portion. The hanging portion is housed in the vertical groove of the housing groove 15b3. The second engaging portion 34b is a metal plate extending in the Y1′ direction from the Z2′-direction end of the vertical portion of the second L-shaped portion 33b. The second engaging portion 34b is received in and engaged with the engaging hole 15b1 of the housing portion 15b. The second tail portion 35b is a metal plate extending in the Y2′ direction from the Z2′-direction end of the vertical portion of the second L-shaped portion 33b.

The fourth power terminal 30d is a negative (GND) power terminal as shown in FIG. 12A to FIG. 12B. The fourth power terminal 30d is formed of a metal plate. Since the fourth power terminal 30d is symmetric to the second power terminal 30b, only the differences between them will be described. A fourth arm 31d of the fourth power terminal 30d is received in the housing portion body 15d2 of the housing portion 15d. A fourth contact portion 32d of the fourth power terminal 30d protrudes in the X2′ direction out of the housing portion body 15d2 of the housing portion 15d. As described above, the third and fourth contact portions 32c and 32d are exposed at the different places (from the housing portion bodies 15c2 and 15d2, respectively) of the first protruding part 12. A horizontal portion of a fourth L-shaped portion 33d of the fourth power terminal 30d is a metal plate extending in the X2′ direction from the Y2′-direction end of the second arm 31b. The horizontal portion is housed in the horizontal groove of the housing groove 15d3. A hanging portion of the fourth L-shaped portion 33d of the fourth power terminal 30d is a metal plate extending in the Z2′ direction from the X2′-direction end of the horizontal portion. The hanging portion is housed in the vertical groove of the housing groove 15d3. A fourth engaging portion 34d of the fourth power terminal 30d is received in and engaged with the engaging hole 15d1 of the housing portion 15d. The fourth power terminal 30d also includes a tail portion 35d as illustrated in FIG. 10A to FIG. 10B and FIG. 12A to FIG. 12B.

As illustrated, the first to fourth tail portions 35a to 35d and the tail portions 24a to 24e are aligned at intervals along the X1′-X2′ direction such that their lower surfaces are flush with each other. The first to fourth tail portions 35a to 35d and the tail portions 24a to 24e are connectable to electrodes on a circuit board of electronic equipment equipped with the mating connector R.

As shown in FIG. 8A to FIG. 9C, the shield case 40 is formed of a metal plate. The shield case 40 has a shell 41, a pair of legs 42, and another pair of legs 43. The shell 41 is a metal tube having the inner shape conforming to the outer shape of the tube 510a of the shield case 500a of the connector P. The shell 41 includes a bottom plate, a top plate, and a pair of side plates. The bottom plate is opposed to the top plate. One of the pair of side plates connects between the X1′-direction end of the bottom plate and the X1′-direction end of the top plate. The other side plate connects between the X2′-direction end of the bottom plate and the X2′-direction end of the top plate in the X2′. The bottom plate is smaller in the Y1′-Y2′ direction than the top plate and than each of the side plates. The Y2′-direction end portion of the top plate of the shell 41 and the Y2′-direction end of the side plates of the shell 41 define rear space. The rear space serves to house the base 11 of the body 10, with the base 11 abutting the Y2′-direction end of the bottom plate. The bottom plate, the portion of the top plate excluding the Y2′-direction end portion, and the portions of the side plates excluding the Y2′-direction end portions of the shell 41 define a front space. The front space receives the first and second protruding parts 12 and 13 of the body 10. The front space also receives the contact portions 21a, 21b, 21d, and 21e of the signal terminals 20a and 20b, 20d, 20e and the contact portion 21c of the ground terminal 20c protruding out of the second protruding part 13, and the first to fourth contact portions 32a to 32d of the first to fourth power terminals 30a to 30d protruding out of the first protruding part 12.

The legs 42 are plates formed by cutting portions in the Y1′-direction side of the bottom plate and the side plates of the shell 41 and extend in the Z2′ direction. The legs 43 are plates formed by cutting portions in the Y2′-direction side of the bottom plate and the side plates of the shell 41 and extend in the Z2′ direction. The legs 42 and 43 are connectable to through-hole electrodes in the circuit board of the electronic component.

The mating connector R may be assembled in the following manner. First, the body 10, the signal terminals 20a, 20b, 20d, and 20e and the ground terminal 20c are prepared. The signal terminals 20a, 20b, 20d, and 20e, particularly the contact portions 21a, 21b, 21d, and 21e and the engaging portions 22a, 22b, 22d, and 22e, are respectively inserted into the engaging holes 14a1, 14b1, 14d1, and 14e1 of the body 10 from the Y2′ direction. The inserted engaging portions 22a, 22b, 22d, and 22e are engaged with the engaging holes 14a1, 14b1, 14d1, and 14e1, respectively. Also, the contact portion 21a, 21b, 21d, 21e are received in the housing grooves 14a2, 14b2, 14d2, and 14e2 of the second protruding part 13 of the body 10, and the contact portions 21a, 21b, 21d, and 21e are exposed from the housing grooves 14a2, 14b2, 14d2, and 14e2, respectively, in the Z2′ direction. The L-shaped portions 23a and 23e of the signal terminals 20a and 20e are respectively received in the housing grooves 14a3 and 14e3 of the body 10, and the hanging portions 23b and 23d of the signal terminals 20b and 20d are respectively received in the housing grooves 14b3 and 14d3 of the body 10.

Similarly, the contact portion 21c and the engaging portion 22c of the ground terminal 20c are inserted into the engaging hole 14c1 of the body 10 from the Y2′ direction. The inserted engaging portion 22c is engaged with the engaging hole 14c1. Also, the contact portion 21c is received in the housing groove 14c2 of the second protruding part 13 of the body 10, and the contact portion 21c is exposed from the housing groove 14c3 in the Z2′ direction. The hanging portion 23c of the ground terminal 20c is received in the housing groove 14c3 of the body 10. The ground terminal 20c is thus disposed between the signal terminal 20b and the signal terminal 20d.

The first to fourth power terminals 30a to 30d are also prepared. The first to fourth power terminals 30a to 30d, particularly the first to fourth contact portions 32a to 32d and the first to fourth arms 31a to 31d, are respectively inserted into the housing portion body 15a2 to 15d2 of the body 10. Simultaneously, the first to fourth engaging portions 34a to 34d of the first to fourth power terminals 30a to 30d are respectively engaged with the engaging hole 15a1 to 15d1 of the body 10. Then, the first and third contact portions 32a and 32c protrude in the Z2′ direction from the housing portion bodies 15a2 and 15c2 (the Z2′-direction end face of the first protruding part 12). The second contact portion 32b protrudes in the X1′ direction from the housing portion body 15b2 (the X1′-direction end face of the first protruding part 12). The fourth contact portion 32d protrudes in the X2′ direction from the housing portion body 15d2 (the X2′-direction end face of the first protruding part 12). The first and third hanging portions 33a and 33c of the first and third power terminals 30a and 30c are housed in the housing grooves 15a3 and 15c3 of the body 10. The second and fourth L-shaped portions 33b and 33d of the second and fourth power terminals 30b and 30d are respectively housed in the housing grooves 15b3 and 15d3 of the body 10. As a result, the first hanging portion 33a is disposed between the L-shaped portion 23a and the hanging portion 23b, and the first tail portion 35a is disposed between the tail portion 24a and the tail portion 24b. The third hanging portion 33c is disposed between the L-shaped portion 23e and the hanging portion 23d, and the third tail portion 35c is disposed between the tail portion 24e and the tail portion 24d. The first to fourth tail portions 35a to 35d and the tail portions 24a to 24e are aligned at intervals in the X1′-X2′ direction such that their lower surfaces are flush with each other

The shield case 40 is also prepared. Into the front space of the shell 41 of the shield case 40 inserted are the first and second protruding parts 12 and 13 of the body 10 to house the base 11 of the body 10 in the rear space of the shell 41. The base 11 then abuts on the shell 41. This is how the mating connector R may be assembled.

The assembled mating connector R may be connected to the connector P in the following manner. The tube 510a and the protruding part 120 of the connector P are fitted into the front space of the shell 41 of the mating connector R. On the other hand, the first and second protruding parts 12 and 13 of the mating connector R are fitted into the connection hole of the connector P. Then, the first contact portion 32a of the first power terminal 30a of the mating connector R elastically contacts the third contact portion 210c of the third terminal 200c of the connector P. The second contact portion 32b of the second power terminal 30b of the mating connector R elastically contacts the fourth contact portion 210d of the fourth terminal 200d of the connector P. The third contact portion 32c of the third power terminal 30c of the mating connector R elastically contacts the first contact portion 210a of the first terminal 200a of the connector P. The fourth contact portion 32d of the fourth power terminal 30d of the mating connector R elastically contacts the second contact portion 210b of the second terminal 200b of the connector P. The claws 321 of the lock pieces 300 of the connector P are engaged with engaging holes in the top plate of the shell 41.

The mating connector R has at least the following technical features. First, the mating connector R realizes power supply to electronic equipment through two electrical systems by way of the first and second power terminals 30a and 30b and the third and fourth power terminals 30c and 30d.

Second, he mating connector R has improved connection reliability for the reasons below. The first and second contact portions 32a and 32b of the first and second power terminals 30a and 30b are exposed from different places of the first protruding part 12, and the third and fourth contact portions 32c and 32d of the third and fourth power terminals 30c and 30d are exposed from different places of the first protruding part 12. In this arrangement, even if the connector P as fitting in the front space of the connector P is pried, it is still possible to maintain the electrical connection of at least one of the first and second contact portions 32a and 32b to at least one of the third and fourth contact portions 210c and 210d of the third and fourth terminals 200c and 200d of the connector P, and the electrical connection of at least one of the third and fourth contact portions 32c and 32d to at least one of the first and second contact portions 210a and 210b of the first and second terminals 200a and 200b of the connector P.

Third, the mating connector R is connectable to a different type of plug connector with contacts that are contactable with the contact portions 21a and 21b of the signal terminals 20a and 20b, the contact portion 21c of the ground terminal 20e, and the contact portions 21d and 21e of the signal terminals 20d and 20e but not contactable with the first to fourth power terminals 30a to 30d. This is made possible by the arrangement of contacts of the mating connector R. Particularly, the contact portions 21a and 21b of the signal terminals 20a and 20b, the contact portion 21c of the ground terminal 20c, and the contact portions 21d and 21e of the signal terminals 20d and 20e are exposed from the surface on the Z2′-direction side of the second protruding part 13. The first and third contact portions 32a and 32c of the first and third power terminals 30a and 30c protrude in the Z2′ direction from the Z2′-direction end face of the first protruding part 12. The second and fourth contact portions 32b and 32d of the second and fourth power terminals 30b and 30d protrude from the X1′- and X2′-direction end faces of the first protruding part 12.

The connector P and the mating connector R are not limited to the configurations of the above-mentioned embodiment, but they may be modified in any manner within the scope of the Claims. Specific modifications will be described below in detail.

The first terminal of the connector of the above embodiment includes the first contact portion, the first engaging portion, the first bent portion, and the first connecting portion. However, the first terminal of the connector of the invention may be any contact including the first contact portion and the first connecting portion. For example, the first terminal may include the first contact portion, the first engaging portion, and the first connecting portion.

The third terminal of the connector of the above embodiment includes the third contact portion, the third engaging portion, the third bent portion, and the third connecting portion. However, the third terminal of the connector of the invention may be any contact including the third contact portion and the third connecting portion. For example, the third terminal may include the third contact portion, the third engaging portion, and the third connecting portion.

The second terminal of the connector of the above embodiment includes the second contact portion, the second engaging portion, the second extended portion, and the second connecting portion. However, the second terminal of the connector of the invention may any contact including the second contact portion and the second connecting portion. For example, the second terminal may include the second contact portion, the second engaging portion, and the second connecting portion.

The fourth terminal of the connector of the above embodiment includes the fourth contact portion, the fourth engaging portion, the fourth extended portion, and the fourth connecting portion. However, the fourth terminal of the connector of the invention may be any contact including the fourth contact portion and the fourth connecting portion. For example, the fourth terminal may include the fourth contact portion, the fourth engaging portion, and the fourth connecting portion.

The first connecting portion of the first terminal of the connector of the invention may be embedded in the first bottom of the first recess of the body so as to be exposed from the first bottom, may be disposed on the first bottom, or may be disposed above the first bottom with a clearance therebetween. Alternatively, the first connecting portion may be disposed on top of and in contact with the second portion of the second connecting portion of the second terminal.

The third connecting portion of the third terminal of the connector of the invention may be embedded in the second bottom of the second recess of the body so as to be exposed from the second bottom, may be disposed on the second bottom, or may be disposed above the second bottom with a clearance therebetween. Alternatively, the third connecting portion may be disposed on top of and in contact with the second portion of the fourth connecting portion of the fourth terminal.

The second connecting portion of the second terminal of the connector of the invention may be provided in the first side wall of the first recess of the body so as to be exposed from the first side wall, may be disposed on the first side wall, or may be disposed on the first bottom of the first recess. In the third case, the first connecting portion of the first terminal may be disposed on and in contact with the second connecting portion. The first portion of the second connecting portion of the invention may be provided in the first side wall of the first recess so as to be exposed from the first side wall, or may be disposed on the first side wall of the first recess. The second portion of the second connecting portion of the invention may be contiguous with the first portion of the second connecting portion and disposed under and in contact with the first connecting portion, or may be contiguous with the first portion of the second connecting portion and disposed on and in contact with the first connecting portion. The first and second connecting portions of the invention may be integral with each other.

The fourth connecting portion of the fourth terminal of the connector of the invention may be provided in the second side wall of the second recess of the body so as to be exposed from the second side wall, may be disposed on the second side wall, or may be disposed on the second bottom of the second recess. In the third case, the third connecting portion of the third terminal may be disposed on and in contact with the fourth connecting portion. The first portion of the fourth connecting portion of the invention may be provided in the second side wall of the second recess so as to be exposed from the second side wall, or may be disposed on the second side wall of the second recess. The second portion of the fourth connecting portion of the invention may be contiguous with the first portion of the fourth connecting portion and be disposed under and in contact with the third connecting portion, or may be contiguous with the first portion of the fourth connecting portion and be disposed on and in contact with the third connecting portion. The third and fourth connecting portions of the invention may also be integral with each other.

The first to fourth contact portions of the first to fourth terminals of the connector of the invention may be modified in any manner if provided in the connection part of the body of the connector so as to be connectable with the terminals of the mating connector. For example, the first to fourth contact portions may be embedded in the connecting portions or housed in recesses, grooves, or holes in the connecting portions, so as to be exposed or protruded from the same face or different faces of the connecting portion. The first and second contact portions of the first and second terminals may be exposed from the same face of the connection part of the body. The third and fourth contact portions of the third and fourth terminals may be modified to be exposed from the same face of the connection part of the body.

The first connecting portion 240a of the connector P of the above embodiment has smaller outer dimensions than the second portion 242b of the second connecting portion 240b because of the first and second cut-outs provided in the first connecting portion 240a. However, the first connecting portion of the invention smaller outer dimensions than the second portion of the second connecting portion due to other factors. For example, the first connecting portion may be smaller in the X1-X2 direction and/or Y1-Y2 direction than the second portion of the second connecting portion. The outer dimensions of the first connecting portion of the invention may be substantially equal to or larger than those of the second portion of the second connecting portion. If the first connecting portion is disposed below the second connecting portion or the second portion of the second connecting portion, the outer dimensions of the second connecting portion or the second portion of the second connecting portion may be substantially equal to, smaller than, or larger than those of the first connecting portion. The second connecting portion or the second portion of the second connecting portion may have smaller outer dimensions than the first connecting portion due to any factor described above. The outer dimensions of the third and fourth connecting portions may be also modified in a similar manner as in the first and second connecting portions.

The first to fourth terminals of the above embodiment are power terminals. The first to fourth terminals of the invention are not limited to power terminals. In the embodiment, the first and second terminals are positive (Vcc) terminals, and the third and fourth terminals are negative (GND) terminals. Alternatively, the first and second terminals of the invention may be negative (GND) terminals, and the third and fourth terminals of the invention may be positive (Vcc) terminals.

The body of the connector of the invention may be modified in any manner as long as it includes the connection part and the first and second recesses, the first recess has the first bottom and the first side wall, and the second recess has the second bottom and the second side wall. The first side wall of the invention may be a side wall of the first recess on the closer side to the center of the connector, and/or may be inclined with respect to the first bottom. The second side wall of the invention may be a side wall of the second recess on the closer side to the center of the connector, and/or may be inclined with respect to the second bottom. The body of the connector of the invention may have any configuration adapted to hold the first, second, third, and fourth terminals of the embodiment and the modified examples described above. For example, the body of the connector may have the first, second, third, and fourth terminals of the embodiment or any of the modified examples embedded therein by insert molding or other means.

The connection part of the body of the connector of the above embodiment is a recess adapted to fittingly receive the first and second protruding parts of the mating connector. However, the connection part of the invention may be modified in any manner if connectable to the mating connector. For example, the connection part may be modified to be a convex part to fit in the mating connector.

The first and second core wires of the cable of the above embodiment are the first and second connection objects. However, the first connection object of the invention may be modified in any manner if connectable in the first recess to the first and second connecting portions of the embodiment or any of the modified examples described above. The second connection object of the invention may be modified in any manner if connectable in the second recess to the third and fourth connecting portions of the embodiment or any of the modified examples described above. For example, the first and second connection objects may be terminals, pins, or protrusions of a circuit board. In any of these cases, the connector of the invention may be modified to a receptacle connector. The shield cases 500a and 500b, the case 600, and/or the insulating tape 700 may be omitted. The first connection object may be connected to the first and second connecting portions of the invention by soldering, or by welding or physical contact. Similarly, the second connection object may be connected to the third and fourth connecting portions of the invention by soldering, or by welding or physical contact.

The mating connector of the invention may be modified in any manner as long as it includes the body having an insulation property and the pair of power terminals held by the body, one of the power terminals is contactable with one of the first and second contact portions of the first and second terminals according to any of the above-mentioned aspects, and the other power terminal is contactable with one of the third and fourth contact portions of the third and fourth terminals according to any of the above-mentioned aspects. In other words, it is possible to omit one of the first and second power terminals and one of the third and fourth power terminals. The power terminals may each have a contact portion partially exposed from the first protruding part of the body of the mating connector, and the signal terminals may each have a contact portion partially exposed from the second protruding part of the body of the mating connector. The power terminals and the signal terminals may be exposed or protruded from the same place (for example, the base or the first protruding part) of the body of the mating connector.

The mating connector of the invention may be modified to include a body having an insulation property, a first power terminal held by the body and contactable with the third contact portion of the third terminal, a second power terminal held by the body and contactable with the fourth contact portion of the fourth terminal, a third power terminal held by the body and contactable with the first contact portion of the first terminal, and a fourth power terminal held by the body and contactable with the second contact portion of the second terminal. That is, the signal terminal can be omitted. Alternatively, the mating connector of the invention may include at least one signal terminal. The signal terminal(s) and the first to fourth power terminals of the mating connector of the invention may have contact portions exposed or protruded from the same place (the base or the first protruding part) of the body. Also, the mating connector of the invention may be modified to a plug connector, by connecting the signal terminal(s) or the first to fourth power terminals used as the signal terminals to a cable. The signal terminal(s) of the mating connector of the invention may be used as a terminal or terminals for transmitting single ended signals.

It should be appreciated that the embodiments and modifications are described above by way of examples only. The materials, shapes, dimensions, numbers, arrangements, and other configurations of the constituents of the connector and the mating connector may be modified in any manner if they can perform similar functions. The configurations of the embodiment and the modified examples described above may be combined in any possible manner.

### REFERENCE SIGNS LIST

P: Connector
100: Body
110: Base
120: Protruding part
130a: First recess
131a: First bottom
132a: First side wall
130b: Second recess
131b: Second bottom
132b: Second side wall
140: Connecting portion
150a: Housing portion
150b: Housing portion
150c: Housing portion
150d: Housing portion
160: Housing portion
200a: First terminal
210a: First contact portion
220a: First engaging portion
230a: First bent portion
240a: First connecting portion
200b: Second terminal
210b: Second contact portion
220b: Second engaging portion
230b: Second extended portion
240b: Second connecting portion
241b: First portion
242b: Second portion
200c: Third terminal
210c: Third contact portion
220c: Third engaging portion
230c: Third bent portion
240c: Third connecting portion
200d: Fourth terminal
210d: Fourth contact portion
220d: Fourth engaging portion
230d: Fourth extended portion
240d: Fourth connecting portion
241d: First portion
242d: Second portion
300: Lock piece
400: Cable
410a: First core wire (first connection object)
410b: Second core wire (second connection object)
420: Insulator
500a: Shield case
500b: Shield case
600: Case
700: Blocking plate
R: Mating connector
10: Body
20a: Signal terminal
20b: Signal terminal
20c: Ground terminal
20d: Signal terminal
20e: Signal terminal
30a: First power terminal
30b: Second power terminal
30c: Third power terminal
30d: Fourth power terminal
40: Shield case

1. A connector comprising:
a body having an insulation property, the body including:
a connection part;
a first recess including a first bottom and a first side wall; and
a second recess including a second bottom and a second side wall;
first, second, third, and fourth terminals held by the body, the first terminal including:
a first contact portion provided at the connection part of the body, and
a first connecting portion, provided in the first bottom of the body so as to be exposed from the first bottom, or provided on the first bottom, or provided with clearance from the first bottom,
the second terminal including:
a second contact portion provided at the connection part of the body, and
a second connecting portion, provided in the first side wall of the body so as to be exposed from the first side wall, or provided on the first side wall,
the third terminal including:
a third contact portion provided at the connection part of the body, and
a third connecting portion, provided in the second bottom of the body so as to be exposed from the second bottom, or provided on the second bottom, or provided with clearance from the second bottom,
the fourth terminal including:
a fourth contact portion provided at the connection part of the body, and
a fourth connecting portion, provided in the second side wall of the body so as to be exposed from the second side wall, or provided on the second side wall, and
first and second connection objects, the first connection object being connected to the first and second connecting portions in the first recess, the second connection object being connected to the third and fourth connecting portions in the second recess.

2. The connector according to claim 1, wherein
the second connecting portion includes:
a first portion, provided in the first side wall of the body so as to be exposed from the first side wall, or provided on the first side wall; and
a second portion contiguous with the first portion, the second portion being located under and in contact with the first connecting portion, and
the fourth connecting portion includes:
a first portion, provided in the second side wall of the body so as to be exposed from the second side wall, or provided on the second side wall; and
a second portion contiguous with the first portion of the fourth connecting portion, the second portion of the fourth connecting portion being located under and in contact with the third connecting portion.

3. The connector according to claim 2, wherein
the first connecting portion has smaller outer dimensions than the second portion of the second connecting portion, and
the third connecting portion has smaller outer dimensions than the second portion of the fourth connecting portion.

4. The connector according to claim 1, wherein
the second connecting portion includes:
a first portion, provided in the first side wall of the body so as to be exposed from the first side wall, or provided on the first side wall; and
a second portion contiguous with the first portion, the second portion being located on top of and in contact with the first connecting portion, and
the fourth connecting portion includes:
a first portion, provided in the second side wall of the body so as to be exposed from the second side wall, or provided on the second side wall; and
a second portion contiguous with the first portion of the fourth connecting portion, the second portion of the fourth connecting portion being located on top of and in contact with the third connecting portion.

5. The connector according to claim 4, wherein
the second portion of the second connecting portion has smaller outer dimensions than the first connecting portion, and
the second portion of the fourth connecting portion has smaller outer dimensions than the third connecting portion.

6. A connector comprising:
a body having an insulation property, the body includes:
a connection part,
a first recess including a first bottom and a first side wall, and
a second recess including a second bottom and a second side wall, first, second, third, and fourth terminals held by the body, the second terminal including:
a second contact portion provided at the connection part of the body, and
a second connecting portion provided on the first bottom of the body,
the first terminal including:
a first contact portion provided at the connection part of the body, and
a first connecting portion provided on the second connecting portion,
the fourth terminal including:
a fourth contact portion provided at the connection part of the body, and
a fourth connecting portion provided on the second bottom of the body,
the third terminal including:
a third contact portion provided at the connection part of the body, and
a third connecting portion provided on the fourth connecting portion; and
first and second connection objects, the first connection object being connected to the first and second connecting portions in the first recess, the second connection object being connected to the third and fourth connecting portions in the second recess.

7. The connector according to claim 1, wherein
the first and second connecting portions are integral with each other, and
the third and fourth connecting portions are integral with each other.

8. The connector according to claim 6, wherein
the first and second connecting portions are integral with each other, and
the third and fourth connecting portions are integral with each other.

9. The connector according to claim 1, further comprising a cable, the cable including:
a first core wire serving as the first connection object, and
a second core wire serving as the second connection object.

10. The connector according to claim 6, further comprising a cable, the cable including:
a first core wire serving as the first connection object, and
a second core wire serving as the second connection object.

11. The connector according to claim 1, wherein
the first and second contact portions are provided at the connection part so as to be at least partially exposed from different places of the connection part, and
the third and fourth contact portions are provided at the connection part so as to be at least partially exposed from different places of the connection part.

12. The connector according to claim 6, wherein
the first and second contact portions are provided at the connection part so as to be at least partially exposed from different places of the connection part, and
the third and fourth contact portions are provided at the connection part so as to be at least partially exposed from different places of the connection part.

13. A mating connector connectable to the connector according to claim 1, the mating connector comprising:
a body having an insulation property;
a signal terminal held by the body of the mating connector;
a first power terminal held by the body of the mating connector so as to be contactable with the third contact portion of the third terminal;
a second power terminal held by the body of the mating connector so as to be contactable with the fourth contact portion of the fourth terminal;
a third power terminal held by the body of the mating connector so as to be contactable with the first contact portion of the first terminal; and
a fourth power terminal held by the body of the mating connector so as to be contactable with the second contact portion of the second terminal.

14. A mating connector connectable to the connector according to claim 6, the mating connector comprising:
a body having an insulation property;
a signal terminal held by the body of the mating connector;
a first power terminal held by the body of the mating connector so as to be contactable with the third contact portion of the third terminal;
a second power terminal held by the body of the mating connector so as to be contactable with the fourth contact portion of the fourth terminal;
a third power terminal held by the body of the mating connector so as to be contactable with the first contact portion of the first terminal; and
a fourth power terminal held by the body of the mating connector so as to be contactable with the second contact portion of the second terminal.

15. The mating connector according to claim 13, wherein
the body of the mating connector includes:
a base;
a first protruding part provided on the base; and
a second protruding part provided on the first protruding part,
the first, second, third, and fourth power terminals include first, second, third, and fourth contact portions, respectively, partially exposed from the first protruding part, and
the signal terminal includes a contact portion partially exposed from the second protruding part.

16. The mating connector according to claim 14, wherein
the body of the mating connector includes:
a base;
a first protruding part provided on the base; and
a second protruding part provided on the first protruding part,
the first, second, third, and fourth power terminals include first, second, third, and fourth contact portions, respectively, partially exposed from the first protruding part, and
the signal terminal includes a contact portion partially exposed from the second protruding part.

17. The mating connector according to claim 15, wherein
the exposed parts of the first and second contact portions are exposed from different places of the first protruding part, and
the exposed parts of the third and fourth contact portions are exposed at different places of the first protruding part.

18. The mating connector according to claim 16, wherein
the exposed parts of the first and second contact portions are exposed from different places of the first protruding part, and
the exposed parts of the third and fourth contact portions are exposed at different places of the first protruding part.

19. A mating connector connectable to the connector according to claim 1, wherein
the mating connector comprising:
a body having an insulation property;
a signal terminal held by the body of the mating connector; and
a pair of power terminals held by the body of the mating connector, one of the power terminals being contactable with one of the first and second contact portions of the first and second terminals, and
the other power terminal being contactable with one of the third and fourth contact portions of the third and fourth terminals.

20. A mating connector connectable to the connector according to claim 6, wherein
the mating connector comprising:
a body having an insulation property;
a signal terminal held by the body of the mating connector; and
a pair of power terminals held by the body of the mating connector, one of the power terminals being contactable with one of the first and second contact portions of the first and second terminals, and
the other power terminal being contactable with one of the third and fourth contact portions of the third and fourth terminals.

21. The mating connector according to claim 19, wherein
the body of the mating connector includes:
a base;
a first protruding part provided on the base;
a second protruding part provided on the first protruding part;
the power terminals each include a contact portion partially exposed from the first protruding part, and
the signal terminal include a contact portion partially exposed from the second protruding part.

22. The mating connector according to claim 20, wherein
the body of the mating connector includes:
a base;
a first protruding part provided on the base;
a second protruding part provided on the first protruding part;
the power terminals each include a contact portion partially exposed from the first protruding part, and
the signal terminal include a contact portion partially exposed from the second protruding part.
